(19) United States
(12) Patent Application Publication
(10) Pub. No.: US 2026/0220970 A1
(43) Pub. Date: Jul. 30, 2026

(54) ELECTRONIC APPARATUS AND METHOD FOR OPERATING THE SAME AND STORAGE MEDIUM

(71) Applicant: SAMSUNG ELECTRONICS CO., LTD., Suwon-si (KR)

(72) Inventors: Sunghyun CHOI, Suwon-si (KR); Sukun YOON, Suwon-si (KR); Jihoon AHN, Suwon-si (KR); Taehyeong KIM, Suwon-si (KR)

(73) Assignee: SAMSUNG ELECTRONICS CO., LTD., Suwon-si (KR)

(21) Appl. No.: 19/577,748

(22) Filed: Mar. 25, 2026

Related U.S. Application Data
(63) Continuation of application No. PCT/KR2025/022192, filed on Dec. 18, 2025.

(30) Foreign Application Priority Data
Dec. 31, 2024 (KR) 10-2024-0202658

(51) Int. Cl. G06V 40/20; G05D 1/689; G05D 101/15; G06F 3/14; G06T 7/20; G06T 7/70; G06V 10/70; G10L 15/22; H04N 9/31

(52) U.S. Cl. CPC G06V 40/20; G05D 1/689; G06F 3/14; G06T 7/20; G06T 7/70; G06V 10/70; G10L 15/22; H04N 9/3173; G05D 2101/15; G06T 2207/10024; G06T 2207/30196; G06T 2207/30252; G10L 2015/223

(57) ABSTRACT

An electronic apparatus, including: at least one sensor; an image projector; at least one processor including processing circuitry; and a memory storing instructions which, when individually or collectively executed by the at least one processor, cause the electronic apparatus to: obtain, using an artificial intelligence model, behavior pattern information about at least one behavior pattern corresponding to a user based on at least one of context information corresponding to the user and tracking information about the user obtained using the at least one sensor, move the electronic apparatus to a location corresponding to a predicted behavior based on the behavior pattern information, and provide display information corresponding to the predicted behavior using the image projector.

### CROSS-REFERENCE TO RELATED APPLICATION(S)

This application is a continuation application, claiming priority under 35 U.S.C. § 365(c), of an International application No. PCT/KR2025/022192, filed on Dec. 18, 2025, which is based on and claims the benefit of a Korean patent application number 10-2024-0202658, filed on Dec. 31, 2024, in the Korean Intellectual Property Office, the disclosure of which is incorporated by reference herein in its entirety.

### BACKGROUND

### 1. Field

The present disclosure relates to an electronic apparatus and a method for operating the same and a storage medium, and more particularly, to an electronic apparatus for providing a service based on a predicted user behavior, a method for operating the same, and a storage medium.

### 2. Description of Related Art

A mobile electronic apparatus (e.g., a robot) that includes a projector may be configured to move within a specific space (e.g., a home, a restaurant, or an airport) while using the projector to provide a user with information. The projector may refer to an electronic apparatus for projecting light onto a projection surface (e.g., a screen) to form an image on the projection surface.

An artificial intelligence system may refer a computer system that may achieve human-level intelligence. The artificial intelligence system may refer to a system in which a machine learns and determines autonomously, and has a recognition rate that improves according to use.

Artificial intelligence technology may include machine learning (e.g., deep learning) techniques that utilize algorithms to autonomously classify and learn features of input data, as well as component technologies that utilize machine learning algorithms to mimic the cognitive and decision-making functions of a human brain.

The component technologies may include, for example, at least one of linguistic understanding technology for recognizing human language/characters, visual understanding technology for recognizing objects as if recognized by human vision, inference/prediction technology for determining information and logically performing inference and prediction, knowledge representation technology for processing human experience information into knowledge data, and operation control technology for controlling autonomous driving of vehicles and movements of robots.

Linguistic understanding may refer to a technology for recognizing, applying, and processing human language/characters. The linguistic understanding may include at least one of natural language processing, machine translation, conversational systems, question answering, speech recognition/synthesis, and the like.

Visual understanding may refer to a technology for recognizing and processing an object as if recognized by human vision. The visual understanding may include at least one of object recognition, object tracking, image search, person recognition, scene understanding, spatial understanding, image enhancement, and the like.

### SUMMARY

In accordance with an aspect of the disclosure, an electronic apparatus includes: at least one sensor; an image projector; at least one processor including processing circuitry; and a memory storing instructions which, when individually or collectively executed by the at least one processor, cause the electronic apparatus to: obtain, using an artificial intelligence model, behavior pattern information about at least one behavior pattern corresponding to a user based on at least one of context information corresponding to the user and tracking information about the user obtained using the at least one sensor, move the electronic apparatus to a location corresponding to a predicted behavior based on the behavior pattern information, and provide display information corresponding to the predicted behavior using the image projector.

The tracking information may include user location information and user behavior history information, and the instructions, when individually or collectively executed by the at least one processor, may further cause the electronic apparatus to: obtain a probability value for each behavior pattern from among the at least one behavior pattern using the artificial intelligence model based on the user location information and the user behavior history information.

The artificial intelligence model may be trained using at least one of a reinforcement learning algorithm or a collaborative filtering algorithm.

The electronic apparatus may further include at least one light-emitting element, and the instructions, when individually or collectively executed by the at least one processor, may further cause the electronic apparatus to: emit light using the at least one light-emitting element based on a probability value associated with a behavior pattern from among the at least one behavior pattern being greater than or equal to a threshold value.

The at least one sensor may include a red-green-blue (RGB) camera sensor, the tracking information may include the user location information, and the instructions, when individually or collectively executed by the at least one processor, may further cause the electronic apparatus to: identify a region in which the user is located from among a plurality of regions based on sensor data obtained using the at least one sensor while performing a patrol operation, and obtain the probability value using the artificial intelligence model based on object location information associated with at least one object included in the region in which the user is located.

The instructions, when individually or collectively executed by the at least one processor, may further cause the electronic apparatus to: obtain the tracking information based on sensor data obtained using at least one external device.

The instructions, when individually or collectively executed by the at least one processor, may further cause the electronic apparatus to: obtain device usage information from an external device, determine an application associated with the at least one behavior pattern based on the device usage information, and provide application information corresponding to the application using the image projector.

The instructions, when individually or collectively executed by the at least one processor, may further cause the electronic apparatus to: based on determining that the external device is present in a predetermined region, provide the application information based on a connection history between the electronic apparatus and the external device.

The electronic apparatus may further include a communication circuit, and the instructions, when individually or collectively executed by the at least one processor, may further cause the electronic apparatus to: transmit the display information to a first device that is closest to a location corresponding to the predicted behavior from among at least one external device using the communication circuit.

The electronic apparatus may further include a microphone, and the instructions, when individually or collectively executed by the at least one processor, may further cause the electronic apparatus to: based on a user voice input being received through the microphone, update a probability value corresponding to each behavior pattern from among the at least one behavior pattern using the artificial intelligence model according to the user voice input.

In accordance with an aspect of the disclosure, a method for operating an electronic apparatus, the method includes: obtaining, using an artificial intelligence model, behavior pattern information about at least one behavior pattern corresponding to a user based on at least one of context information corresponding to the user or tracking information about the user obtained using at least one sensor; moving the electronic apparatus to a location corresponding to a predicted behavior based on the behavior pattern information; and providing display information corresponding to the predicted behavior using an image projector.

The tracking information may include user location information and user behavior history information, and the method may further include obtaining a probability value for each behavior pattern from among the at least one behavior pattern using the artificial intelligence model based on the user location information and the user behavior history information.

The artificial intelligence model may be trained using at least one of a reinforcement learning algorithm or a collaborative filtering algorithm.

The method may further include: emitting light using at least one light-emitting element based on a probability value associated with a behavior pattern from among the at least one behavior pattern being greater than or equal to a threshold value.

In accordance with an aspect of the disclosure, a storage medium stores computer-readable instructions which, when executed by at least one processor of an electronic apparatus, cause the electronic apparatus to: obtain, using an artificial intelligence model, behavior pattern information about at least one behavior pattern corresponding to a user based on at least one of context information corresponding to the user or tracking information about the user obtained using at least one sensor, move the electronic apparatus to a location corresponding to a predicted behavior based on the behavior pattern information, and provide display information corresponding to the predicted behavior using an image projector.

### BRIEF DESCRIPTION OF DRAWINGS

FIG. 1 is a schematic diagram for describing an electronic apparatus according to an embodiment.

FIG. 2 is a block diagram showing components included in the electronic apparatus according to an embodiment.

FIG. 3 is a flowchart for describing a method for operating an electronic apparatus according to an embodiment.

FIG. 4 is a flowchart for describing an operation for obtaining a probability value according to an embodiment.

FIG. 5 is a flowchart for describing an operation for obtaining a probability value according to an embodiment.

FIG. 6 is a flowchart for describing a method for transmitting information about first content according to an embodiment.

FIG. 7 is a flowchart for describing a method for identifying a predicted user behavior based on a user voice according to an embodiment.

FIG. 8A is a diagram for describing an implementation example of the electronic apparatus according to an embodiment.

FIG. 8B is a diagram for describing map information about a travel space according to an embodiment.

FIG. 9 is a diagram for describing a method for providing content according to an embodiment.

FIG. 10 is a diagram for describing a method for providing the content according to an embodiment.

FIG. 11 is a diagram for describing a method for providing the content according to an embodiment.

FIG. 12 is a flowchart for describing a method for providing information corresponding to an application according to an embodiment.

FIGS. 13A and 13B are diagrams for describing a method for providing information corresponding to an application according to an embodiment.

FIGS. 14A and 14B are diagrams for describing a method for providing information corresponding to an application according to an embodiment.

FIGS. 15A and 15B are diagrams for describing a method for providing information corresponding to an application according to an embodiment.

FIG. 16A and FIG. 16B is a diagram for describing a method for providing information 1620 corresponding to an application according to an embodiment.

FIGS. 17A and 17B are diagrams for describing a method for providing information corresponding to an application according to an embodiment.

FIGS. 18A and 18B are diagrams for describing a method for providing information corresponding to an application according to an embodiment.

FIGS. 19A and 19B are diagrams for describing a method for providing information 1820 corresponding to an application according to an embodiment.

FIGS. 20A and 20B are diagrams for describing a method for providing information corresponding to an application according to an embodiment.

FIG. 21 is a block diagram showing specific components included in an electronic apparatus according to an embodiment.

### DETAILED DESCRIPTION

Hereinafter, embodiments of the present disclosure are described in detail with reference to the accompanying drawings.

Examples of some terms used herein are briefly described, and the present disclosure is then described in detail.

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, expressions such as “have”, “may have”, “include”, or “may include”, may indicate the presence of a corresponding feature (e.g., a numerical value, a function, an operation, or a component such as a part), and do not exclude the presence of an additional feature.

An expression such as “at least one of A or/and B” may indicate either “A or B”, or “both of A and B.” For example, as used herein, expressions such as “at least one of,” when preceding a list of elements, modify the entire list of elements and do not modify the individual elements of the list. For example, the expressions “at least one of A, B, and C,” and “at least one of A, B, or C,” should be understood as including only A, only B, only C, both A and B, both A and C, both B and C, or all of A, B, and C.

Expressions such as “first” and “second”, used in the present disclosure may indicate various components regardless of the sequence or importance of the components. These expression are used only to distinguish one component from another component, and do not limit the corresponding component.

If a component (e.g., a first component) is described as being “(operatively or communicatively) coupled with/to” or “connected to” another component (e.g., a second component), it should be understood that the component is directly coupled to another component or may be coupled to another component through yet another component (e.g., a third component).

A singular term may include the plural unless explicitly indicated otherwise in the context. It should be understood that the terms “include” or “have” used herein may specify the presence of features, numerals, steps, operations, components, parts, or combinations thereof, and do not preclude the presence or addition of one or more other features, numerals, steps, operations, components, parts, or combinations thereof.

In the present disclosure, a “module” or an element having a name ending in the suffixes “-er/-or” (which may be referred to as an “-er/-or” element) may perform at least one function or operation, and be implemented by hardware, software, or a combination of hardware and software. In addition, a plurality of “modules” or a plurality of “-er/-or” elements may be integrated in at least one module and be implemented by the processor (not shown) except for a “module” or an “-er/-or” element that may be implemented by a specific hardware.

In addition, as used herein, the term “signal” may include an electrical signal and also an acoustic signal, and the electrical signal may be at least one of an analog signal and a digital signal. For example, the term “audio signal” (or “noise signal”) may indicate an acoustic signal (or a radio signal) if the signal is external to the electronic apparatus, and may indicate an electrical signal if the signal is internal to the electronic apparatus. In addition, signal processing within the electronic apparatus described below may be, or may include, at least one of digital signal processing, analog signal processing, and a combination of analog and digital signal processing.

In addition, as used herein, the term “filter” may refer to removing a specific component (e.g., a specific frequency region or a specific pattern), and the filter may be at least one of a digital filter and an analog filter.

As used herein, when an action or operation is described as occurring or being performed “if” a condition occurs, this may mean that that the action or operation occurs or is performed based on or in response to the condition occurring (e.g., based on or in response to detecting that the condition occurs or has occurred).

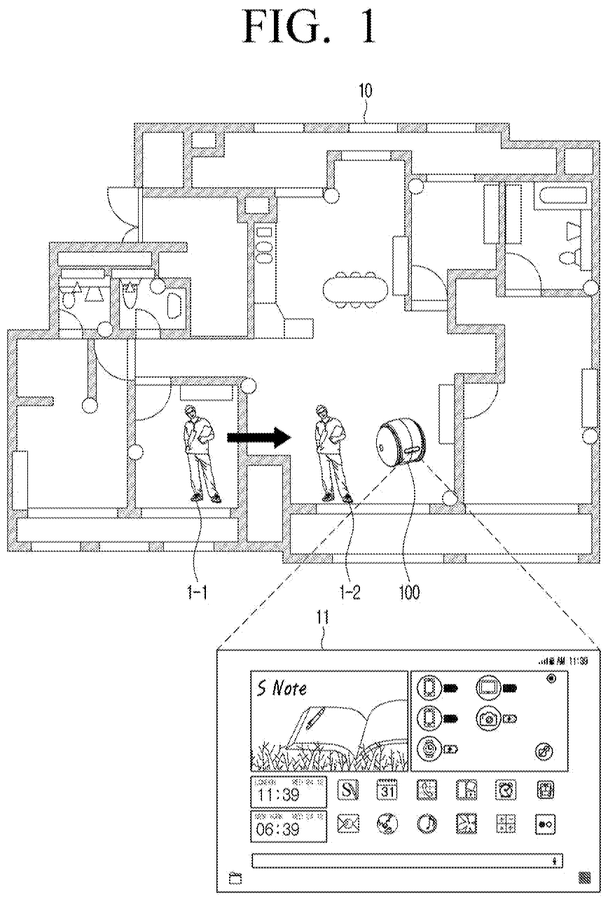

FIG. 1 is a schematic diagram for describing an electronic apparatus according to an embodiment.

Referring to FIG. 1, an electronic apparatus 100 according to an embodiment may travel within a travel space 10. According to an embodiment, the electronic apparatus 100 may track a user present in the travel space. For example, the electronic apparatus 100 may obtain tracking information about the user present in the travel space based on sensor data obtained using at least one sensor. For example, the tracking information may include user location information. For example, if the user moves from a master bedroom 1-1 to a living room 1-2, the electronic apparatus 100 may obtain the tracking information including “a user behavior of moving from the master bedroom to the living room.” For example, the electronic apparatus 100 may obtain context information (e.g., at least one of a current time, a current date, a current weather, and a current temperature) corresponding to the user. For example, the electronic apparatus 100 may obtain various information including the current time, such as “Sunday” and “11:00 ante meridiem (AM),” as the context information.

According to an embodiment, the electronic apparatus 100 may obtain a probability value for each behavior pattern from among at least one behavior pattern corresponding to the user by inputting the obtained tracking information and context information into a trained artificial intelligence model. For example, the user behavior pattern may be a behavior predicted to be performed by a specific user under a specific condition. For example, according to embodiments, a behavior pattern may be, may include, or may otherwise indicate or correspond to one or more predicted behaviors (e.g., one or more predicted actions) that are predicted to be performed or exhibited by a particular user under one or more particular conditions. According to embodiments, inputting information into an artificial intelligence model may also be referred to as providing the information as input to the artificial intelligence model. According to embodiments, a probability value for a behavior pattern may refer to a probability value associated with or corresponding to the behavior pattern. For example, a probability value for a behavior pattern may indicate a predicted probability that the behavior will occur (e.g., will be performed or exhibited by a user).

For example, the electronic apparatus 100 may identify a behavior of “watching television (TV)” as the predicted behavior based on the probability value for at least one behavior pattern, as a behavior pattern exceeding a threshold value.

For example, the electronic apparatus 100 may provide content corresponding to the identified predicted behavior at a specific location. For example, if content corresponding to the behavior of “watching TV” is a “user interface (UI) for controlling the TV” or an “operation corresponding to turning on the TV”, the electronic apparatus 100 may provide the “user interface (UI) for controlling the TV” through a projection unit or transmit a “control signal corresponding to turning on the TV” to the TV.

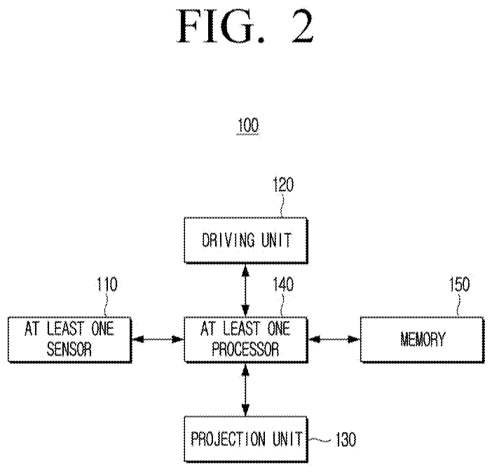

FIG. 2 is a block diagram showing components included in the electronic apparatus according to an embodiment.

Referring to FIG. 2, the electronic apparatus 100 may include at least one sensor 110, a driving unit 120, a projection unit 130, at least one processor 140, and a memory 150.

The electronic apparatus 100 may travel within the travel space. For example, the electronic apparatus may be implemented as a mobile projector that provides an image while moving within the travel space, but embodiments are not limited thereto. For example, the electronic apparatus may be implemented as a robot that travels within the travel space.

The at least one sensor 110 (may include one or a plurality of sensors of various types. The at least one sensor 110 may measure a physical quantity or detect an operation state of the electronic apparatus 100, and convert the measured or detected information into an electrical signal. The at least one sensor 110 may include a camera (e.g., a camera sensor), and the camera may include a lens that focuses visible light or other optical signals reflected and received by an object onto an image sensor, and the image sensor may be capable of detecting visible light or other optical signals. Here, the image sensor may include a two-dimensional (2D) pixel array divided into a plurality of pixels. In some embodiments, at least one sensor 110 may include a temperature sensor or an infrared sensor.

The driving unit 120 may be a component for driving a wheel included in the electronic apparatus 100. For example, the driving unit 120 may include a rotation shaft connected to the wheel, a motor that transmits power to the rotation shaft to drive the wheel, and the like. Accordingly, the processor 140 may drive the wheel through the driving unit 120 to perform various travel operations, such as movement, stop, speed control, direction change, and angular velocity change of the electronic apparatus 100.

The projection unit 130 may be a component for projecting an image to the outside (e.g., to an outside of at least one of the projection unit 130 and the electronic apparatus 100). According to embodiments, the projection unit 130 may project the image onto a display surface such as a screen that is separate from or included in the electronic apparatus 100. In embodiments, the projection unit 130 may be referred to as, for example, at least one of a projection module, a projection device, a projector, and an image projector. According to various embodiments of the present disclosure, the projection unit 130 may be implemented according to any of various projection types (e.g., a cathode-ray tube (CRT) type, a liquid crystal display (LCD) type, a digital light processing (DLP) type, or a laser type). For example, the CRT type may operate according to a principle that is similar to a CRT monitor. The CRT type may display the image on a screen (e.g., project the image onto a screen) by magnifying the image using a lens in front of a cathode-ray tube (CRT). The CRT type may be classified into a single-tube type and a three-tube type based on the number of cathode-ray tubes, and in case of the three-tube type, red, green, and blue cathode-ray tubes may be implemented separately.

As another example, the LCD type may display the image (e.g., project the image onto a screen) by passing light output from a light source through a liquid crystal. The LCD type may be classified into a single-panel type and a three-panel type. In case of the three-panel type, light output from the light source may be separated into red, green, and blue by a dichroic mirror (i.e., a mirror that only reflects light of a specific color and transmits the others), may then pass through the liquid crystal, and may then be focused again onto a single point.

As another example, the DLP type may display the image (e.g., project the image onto a screen) using a digital micromirror device (DMD) chip. The DLP-type projection unit may include at least one of a light source, a color wheel, the DMD chip, a projection lens, and the like. Light that is output from the light source may be colored as the light passes through a rotating color wheel. Light passed through the color wheel may be input to the DMD chip. The DMD chip may include numerous micromirrors and reflect light input into the DMD chip. The projection lens may serve to magnify light reflected from the DMD chip into an image size.

As another example, the laser type may include a diode-pumped solid-state (DPSS) laser and a galvanometer. The laser type may output various colors using a laser in which three DPSS lasers are respectively installed for red, green, and blue (RGB) colors, and the optical axes of the lasers may then overlap with one another using a special mirror. The galvanometer may include a mirror and a high-power motor to move the mirror at a high speed. For example, the galvanometer may rotate the mirror at up to 40 kilohertz (KHz)/sec. The galvanometer may be mounted in a scanning direction. In general, the projector may perform a flatbed scanning, and the galvanometer may thus also be divided into x and y axes.

Meanwhile, the projection unit 130 may include light sources of various types. For example, the projection unit 130 may include at least one light source among a lamp, a light emitting diode (LED), and a laser. In addition, the projection unit 130 may output the image in an aspect ratio of 4:3, an aspect ratio of 5:4, or a wide aspect ratio of 16:9, based on a purpose of the electronic apparatus 100, a user setting, or the like, and may output the image having various resolutions such as wide video graphics array (WVGA, 854*480 pixels), super video graphics array (SVGA, 800*600 pixels), extended graphics array (XGA, 1024*768 pixels), wide extended graphics array (WXGA, 1280*720 pixels), WXGA (1280*800 pixels), super extended graphics array (SXGA, 1280*1024 pixels), ultra extended graphics array (UXGA, 1600*1200 pixels) and full high-definition (full HD, 1920*1080 pixels), based on the aspect ratio.

Although examples are described herein in which the projection unit 130 projects an image onto a display surface such as a screen, embodiments are not limited thereto. For example, in some embodiments, the images that are described herein as being displayed or projected using the projection unit 130 may be displayed in any other manner, for example using a display such as a touchscreen included in the electronic device 100, but embodiments are not limited thereto.

The processor 140 may be electrically connected to at least one sensor 110, the driving unit 120, the projection unit 130, and the memory 150 to control overall operations of the electronic apparatus 100. The processor 140 may include one or more processors. In detail, the processor 140 may perform the operation of the electronic apparatus 100 according to the various embodiments of the present disclosure by executing at least one instruction stored in the memory 150.

According to an embodiment, the processor 140 may be implemented as a digital signal processor (DSP), a microprocessor, a graphics-processing unit (GPU), an artificial intelligence (AI) processor, a neural processing unit (NPU), a time controller (TCON), or the like. However, the processor 140 is not limited thereto, and may include at least one of a central processing unit (CPU), a micro controller unit (MCU), a micro processing unit (MPU), a controller, an application processor (AP), a communication processor (CP), or an advanced RISC (Reduced Instruction Set Computer) machine (ARM) processor, or may be defined by a relevant term. In addition, the processor 140 may be implemented as a system-on-chip (SoC) or a large scale integration (LSI), having a processing algorithm embedded therein, or may be implemented as an application specific integrated circuit (ASIC) or a field programmable gate array (FPGA).

The memory 150 may store data necessary for the various embodiments. The memory 150 may be implemented as a memory embedded in the electronic apparatus 100 or a memory detachable from the electronic apparatus 100, depending on a purpose of the data storage. For example, data for operating the electronic apparatus 100 may be stored in the memory embedded in the electronic apparatus 100, and data for an expanded function of the electronic apparatus 100 may be stored in the memory detachable from the electronic apparatus 100.

Meanwhile, the memory embedded in the electronic apparatus 100 may be implemented as at least one of a volatile memory (e.g., a dynamic RAM (DRAM)), a static RAM (SRAM), or a synchronous dynamic RAM (SDRAM)) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)). In addition, the memory detachable from the electronic apparatus 100 may be implemented as a memory card (e.g., a compact flash (CF) memory, a secure digital (SD) memory, a micro secure digital (Micro-SD) memory, a mini secure digital (Mini-SD) memory, an extreme digital (xD) memory, or a multi-media card (MMC) memory), an external memory which may be connected to a universal serial bus (USB) port (e.g., a USB memory), or the like.

According to an embodiment, the processor 140 may obtain a probability value for at least one user behavior pattern within the travel space. For example, the user behavior pattern may be, or may include, a predicted behavior that is predicted to be performed or exhibited by the specific user under the specific condition. For example, the specific condition may include at least one of the current location, current time, or current date of the user. For example, a father behavior pattern corresponding to a condition that the father moves from the master bedroom to the living room at a time of 8:00 post meridiem (PM) on a weekday may be a behavior of controlling a TV disposed in the living room.

For example, the processor 140 may obtain a probability value for each behavior pattern from among at least one behavior pattern corresponding to a first user by inputting at least one of context information corresponding to the first user in the travel space or first user tracking information obtained using at least one sensor 110 into the trained artificial intelligence model.

For example, the processor 140 may obtain the context information. For example, the context information may be defined as information used for characterizing a state of an entity (e.g., the user). For example, the first user context information may include at least one of the current time, environment information, or history information corresponding to the first user. For example, the processor 140 may obtain the context information using an external device (e.g., a server). In some embodiments, for example, the processor 140 may obtain the context information based on the sensed data obtained using at least one sensor 110. According to embodiments, the sensed data obtained using at least one sensor 110 may be referred to as sensor data. In some embodiments, for example, the processor 140 may obtain the context information based on the sensor data obtained from at least one internet of things (IoT) device present in the travel space.

For example, the environment information may include at least one of information about the current weather, the current temperature within the travel space, or illuminance within the travel space. For example, the history information may include at least one first user behavior during a previous one hour and frequency information corresponding to each behavior. For example, the history information may include information about the number of times the first user moves to a first subspace within the travel space during the previous one hour. In some embodiments, for example, the history information may include usage history information of an application installed on a user terminal corresponding to the first user. According to embodiments, the history information may be referred to as behavior information, user behavior information, behavior history information, and user behavior history information.

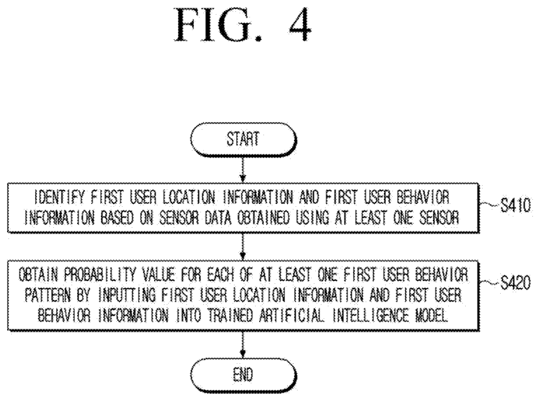

For example, the processor 140 may obtain the first user tracking information from at least one sensor 110. For example, the tracking information may refer to information obtained based on an image corresponding to the first user, and may include information about a current location of the first user within the travel space (e.g., the first subspace within the travel space) and a current behavior of the first user. For example, the processor 140 may track (or monitor) the first user in real time based on the sensor data obtained using at least one sensor 110 if the at least one sensor 110 is implemented as the camera sensor. For example, the processor 140 may obtain information about the location of the first user within the travel space and the first user behavior based on the sensor data obtained by tracking the first user in real time. For example, the behavior information may include information about the movement direction and movement path of the user. This configuration is described in detail with reference to FIG. 4.

Meanwhile, for example, the processor 140 may obtain the tracking information based on the sensor data obtained from at least one internet of things (IoT) device present in the travel space. For example, at least one IoT device (e.g., a TV or a refrigerator) equipped with a camera sensor in the travel space may obtain sensor data associated with the first user, and the processor 140 may receive the sensor data from the at least one IoT device through a communication circuit and obtain the tracking information based on the received data.

For example, the processor 140 may obtain the probability value for each first user behavior pattern from among at least one first user behavior pattern by inputting at least one of the first user context information or the first user tracking information into the trained artificial intelligence model. For example, the artificial intelligence model may be a model trained to output the probability value for each behavior pattern from among at least one behavior pattern based on at least one of the context information or the tracking information being provided as input to the artificial intelligence model. In some embodiments, for example, the artificial intelligence model may be a model trained to output the probability value for each behavior pattern from among at least one behavior pattern based on the context information and the sensor data obtained using at least one sensor 110 are input being provided as input to the artificial intelligence model. A method for training the artificial intelligence model is described below.

For example, the processor 140 may continuously obtain the contextual information and the tracking information by continuously tracking the user. The processor 140 may input the contextual information and the tracking information into the trained artificial intelligence model to update the probability value for each behavior pattern from among at least one behavior pattern in real time.

For example, the memory 150 may store information about at least one behavior pattern corresponding to each of a plurality of users. For example, as shown in Table 1 below, the information about at least one behavior pattern may include the information about at least one behavior pattern corresponding to each of the plurality of users, the corresponding probability value, and content corresponding to the behavior pattern. As described above, the probability value may be updated in real time.

TABLE 1

| Behavior | | | | | | |
|---|---|---|---|---|---|---|
| Pattern | User | Room | Time | Condition | Probability | Provided Content |
| First | Father | Living | 08:00 | Weekday, | 0% | Provide weather |
| Behavior | | room | | located in the | | information and personal |
| Pattern | | | | living room | | schedule information |
| Second | Mother | Living | 15:00 | Weekday, | 10% | Control an operation mode |
| Behavior | | room | | located in the | | of the TV |
| Pattern | | | | living room | | |
| Third | Daughter | Living | 16:00 | Weekday, | 30% | Transmit information about |
| Behavior | | room | | located in the | | content associated with a |
| Pattern | | | | living room | | user to the TV |
| Fourth | Father | Master | 13:00 | Weekend, | 40% | Control the operation mode |
| Behavior | | bedroom | | moves to the | | of the TV |
| Pattern | | | | living room | | |
| Fifth | Father | Master | 20:00 | Weekday, | 90% | Provide information about |
| Behavior | | bedroom | | moves to the | | IoT device disposed in the |
| Pattern | | | | living room | | living room |

Referring to Table 1, “Room” indicates at least one subspace present within the travel space. “Time” indicates a time corresponding to the behavior pattern. “Condition” indicates information about whether the current date is a weekday or weekend and user behavior information. “Probability value” indicates a probability value corresponding to each behavior pattern in a current situation. “Provided Content” indicates content that the electronic apparatus 100 provides to the user.

For example, the user behavior pattern may be a behavior predicted to be performed by the specific user under the specific condition. For example, a first behavior pattern may be a predicted behavior (e.g., a behavior of checking the weather information or a personal schedule) in a case where the father is continuously located in the living room after being present in the living room at 8:00 AM on a weekday. In this case, first content corresponding to the behavior pattern may be “content associated with the weather information and the personal schedule information.”

In some embodiments, for example, a second behavior pattern may be a predicted behavior (e.g., a behavior of controlling the TV) in a case where the mother is continuously located in the living room after being present in the living room at 3:00 PM on a weekday. In some embodiments, for example, a third behavior pattern may be a predicted behavior (e.g., a behavior of watching content playback on the user terminal on the TV using a mirroring function) in a case where the daughter continuously is located in the living room after being present in the living room at 4:00 PM on a weekday. In some embodiments, for example, a fourth behavior pattern may be a predicted behavior (e.g., a behavior of manipulating the TV) in a case where the father moves to the living room after being present in the master bedroom at 1:00 PM on a weekend. In some embodiments, for example, a fifth behavior pattern may be a predicted behavior (e.g., a behavior of manipulating an air conditioner disposed in the living room) in a case where the father moves to the living room after being present in the master bedroom at 8:00 PM on a weekday.

According to an embodiment, the processor 140 may identify the predicted behavior based on the probability value. For example, the predicted behavior refers to a behavior predicted to be performed by the specific user under the specific condition. For example, the predicted behavior may be, or may be associated with or correspond to, a behavior pattern having a probability value greater than or equal to the threshold value from among at least one behavior pattern. For example, the processor 140 may identify the first behavior pattern having the probability value greater than or equal to a first threshold value among at least one behavior pattern as a first predicted behavior of the first user.

For example, referring to Table 1 above, the processor 140 may identify the fifth behavior pattern as the first predicted behavior corresponding to the first user (e.g., the father) if the fifth behavior pattern is identified as a behavior pattern that exceeds the first threshold value (e.g., 80%) among at least one behavior pattern. The processor 140 may track each of the plurality of users if the plurality of users are present in the travel space, and continuously update the probability value for at least one behavior pattern corresponding to each of the plurality of users based thereon.

According to an embodiment, if the predicted behavior is identified, the processor 140 may control the driving unit 120 to move the electronic apparatus 100 based thereon. For example, the processor 140 may control the driving unit 120 to move the electronic apparatus 100 to a first location within the travel space that corresponds to the identified first predicted behavior. For example, the first location may be a location within the travel space for providing content corresponding to the predicted user behavior.

In the example shown in Table 1, the fifth behavior pattern may be identified as the first predicted behavior corresponding to the first user. The processor 140 may control the driving unit 120 to move the electronic apparatus 100 to the living room to provide the father with “information about the IoT device disposed in the living room.”

According to an embodiment, the processor 140 may provide content corresponding to the predicted behavior using the projection unit 130. For example, the content corresponding to the predicted behavior may be content associated with the behavior that the user is predicted to perform. According to embodiments, the content corresponding to the predicted behavior may be, or may include, information corresponding to the predicted behavior, and may be displayed to the user by being projected onto a display surface using the projection unit 130. Accordingly, the content corresponding to the predicted behavior may be referred to as, for example, display information corresponding to the predicted behavior. For example, referring to Table 1, content corresponding to the first behavior pattern (e.g., the behavior of checking the weather information or the personal schedule) may be a user interface (UI) that includes information about the weather information or the personal schedule. In some embodiments, for example, content corresponding to the second behavior pattern (e.g., the behavior of controlling the TV) may be a UI for controlling the TV or an operation for transmitting the control signal to the TV to enable the TV to display a screen of a specific channel.

For example, the first content may be either widget-type content or thumbnail-type content, associated with the first predicted behavior of the first user. For example, if the first predicted behavior is the “behavior for manipulating the IoT device disposed in the living room”, the first content may be a “widget for controlling the IoT device disposed in the living room.” In some embodiments, for example, if the first predicted behavior is “watching a first image on the TV”, the first content may be a “thumbnail for the first image.”

For example, the processor 140 may provide the first content corresponding to the identified first predicted behavior at the first location using the projection unit 130. In the example shown in Table 1, the fifth behavior pattern may be identified as the first predicted behavior corresponding to the first user. The processor 140 may display a UI that includes “the information about the IoT device disposed in the living room” on the projection surface using the projection unit 130.

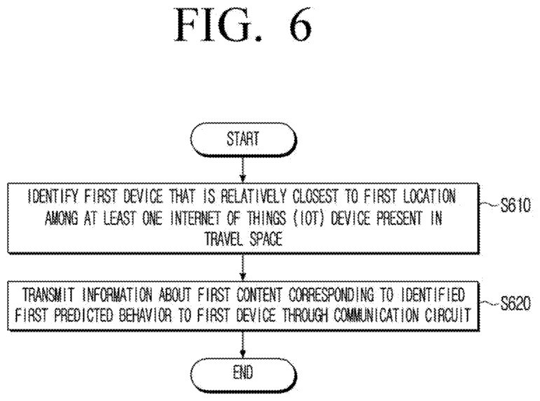

However, the present disclosure is not limited thereto, and for example, the processor 140 may provide content identified using the external device (e.g., an external display device) instead of providing the content to the user using the projection unit 130. This configuration is described in detail with reference to FIG. 6.

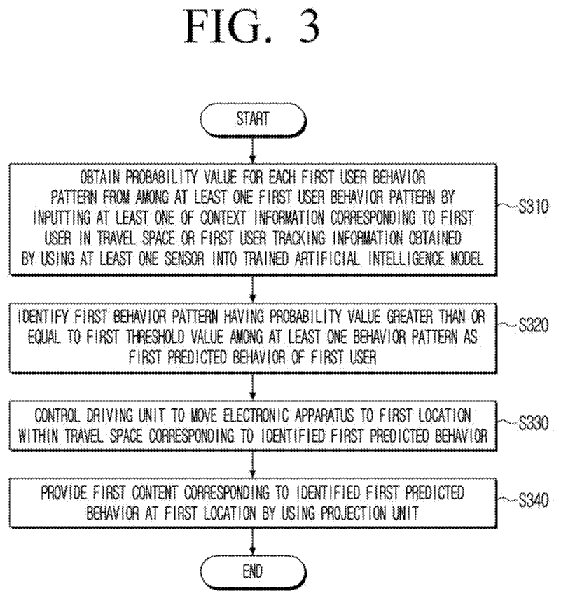

FIG. 3 is a flowchart for describing a method for operating an electronic apparatus according to an embodiment.

Referring to FIG. 3, according to an embodiment, the operating method may include obtaining a probability value for each first user behavior pattern from among at least one first user behavior pattern by inputting at least one of the first user context information in the travel space or the first user tracking information obtained using at least one sensor 110 into the trained artificial intelligence model at operation S310.

For example, the electronic apparatus 100 may obtain at least one of the first user context information or the first user tracking information within the travel space. For example, the electronic apparatus 100 may obtain the probability value for each first user behavior patternat least one first user behavior pattern by inputting at least one of the obtained context information or the tracking information into the trained artificial intelligence model.

According to an embodiment, the operating method may include identifying the first behavior pattern having the probability value greater than or equal to the first threshold value among at least one behavior pattern as the first predicted behavior of the first user at operation S320.

For example, if the probability value for each behavior pattern from among at least one behavior pattern is obtained, the electronic apparatus 100 may identify the first behavior pattern having the probability value greater than or equal to the first threshold value (e.g., 80%) among at least one behavior pattern. For example, the electronic apparatus 100 may identify the identified first behavior pattern as the first predicted behavior of the first user.

According to an embodiment, the operating method may include controlling the driving unit to move the electronic apparatus 100 to the first location within the travel space corresponding to the identified first predicted behavior at operation S330.

For example, if the first predicted behavior is identified, the electronic apparatus 100 may identify the first location within the travel space corresponding to the identified first predicted behavior. For example, information about a moved location (e.g., a new location) of the electronic apparatus 100 corresponding to each behavior pattern from among at least one behavior pattern may be stored in the memory 150. For example, the electronic apparatus 100 may identify the first location within the travel space based on the information stored in the memory 150. For example, the electronic apparatus 100 may control the driving unit 120 to move the electronic apparatus 100 to the identified first location.

According to an embodiment, the operating method may include providing the first content corresponding to the identified first predicted behavior at the first location using the projection unit 130 at operation S340.

For example, the electronic apparatus 100 may provide the first content corresponding to the first predicted behavior at the first location using the projection unit 130. For example, the electronic apparatus 100 may identify the projection surface (e.g., a wall) present within a predetermined distance from the first location, and control the projection unit 130 to display the identified first content on the identified projection surface.

FIG. 4 is a flowchart for describing an operation for obtaining the probability value according to an embodiment.

Referring to FIG. 4, according to an embodiment, the operating method may include identifying the first user location information and the first user behavior information (e.g., first user behavior history information) based on the sensor data obtained using at least one sensor 110 at operation S410.

For example, the tracking information may include at least one of the user location information within the travel space or the user behavior information. For example, the user location information within the travel space may be information about a subspace in which the user is located among at least one subspace included in the travel space, but embodiments are not limited thereto. For example, the location information may include information about a user location within the subspace in which the user is located.

For example, the electronic apparatus 100 may identify the first user location information based on the sensor data obtained using at least one sensor 110 (e.g., the camera sensor). For example, the electronic apparatus 100 may identify a first user location within the travel space while performing a patrol operation for the travel space.

In some embodiments, for example, the electronic apparatus 100 may identify the first user behavior information based on the sensor data. For example, the behavior information may include the information about the movement direction or movement path of the user. For example, the electronic apparatus 100 may continuously track the first user if the first user is present within the travel space, and may identify the first user behavior information based thereon.

According to an embodiment, the operating method may include obtaining the probability value for each first user behavior patternat least one first user behavior pattern by inputting the first user location information and the first user behavior information into the trained artificial intelligence model at operation S420.

For example, if the first user location information and the first user behavior information are identified, the electronic apparatus 100 may input the identified information into the trained artificial intelligence model. For example, the trained artificial intelligence model may be stored in the memory 150, but embodiments are not limited thereto. For example, the electronic apparatus 100 may obtain the probability value for each first user behavior patternat least one first user behavior pattern from the trained artificial intelligence model. However, the present disclosure is not limited thereto, and for example, the electronic apparatus 100 may obtain a probability value for a user behavior pattern other than the first user behavior pattern based on the information corresponding to the first user (e.g., the first user location information and the first user behavior information).

For example, the electronic apparatus 100 may continuously input the location information and the behavior information obtained by tracking the first user into the artificial intelligence model, thereby continuously updating the probability value for the first user behavior pattern.

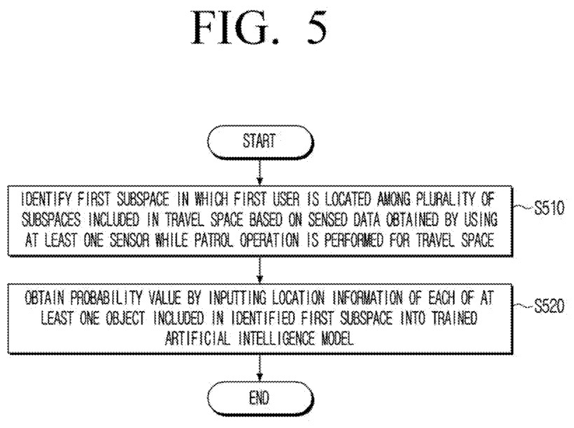

FIG. 5 is a flowchart for describing an operation for obtaining the probability value according to an embodiment.

Referring to FIG. 5, according to an embodiment, the operating method may include identifying the first subspace in which the first user is located among the plurality of subspaces included in the travel space based on the sensor data obtained using at least one sensor 110 while performing the patrol operation for the travel space at operation S510. For example, the memory 150 may store the map information about the travel space. For example, the map information about the travel space may include identification information for each of at least one of the subspaces within the travel space.

For example, the electronic apparatus 100 may perform the patrol operation for the travel space. For example, the electronic apparatus 100 may identify the first subspace, in which the first user is located, based on the sensor data obtained using at least one sensor 110 while performing the patrol operation for the travel space. For example, the electronic apparatus 100 may not only identify the first subspace within the travel space, in which the first user is located, but also identify exact location information of the first user within the first subspace.

For example, at least one sensor 110 may be implemented as a red-green-blue (RGB) camera sensor. The electronic apparatus 100 may obtain an image of the travel space based on the sensor data obtained from the camera sensor while performing the patrol operation. The electronic apparatus 100 may identify the first user in the image using a predetermined algorithm (e.g., a face recognition algorithm). The electronic apparatus 100 may identify the first subspace in which the identified first user is located.

Meanwhile, for example, the electronic apparatus 100 may identify information about a location of at least one object (e.g., the IoT device, light, or furniture) present in the first subspace based on the sensor data obtained from the camera sensor. For example, the electronic apparatus 100 may update the map information about the travel space based on location information of each of at least one obtained object. According to embodiments, the location information of each of at least one object may be referred to as, for example, object location information associated with the at least one object.

According to an embodiment, the operating method may include obtaining the probability value by inputting the location information of each of at least one object included in the identified first subspace into the trained artificial intelligence model at operation S520.

For example, the electronic apparatus may obtain the probability value for each first user behavior patternat least one first user behavior pattern by inputting the information about each of at least one object included in the identified first subspace into the trained artificial intelligence model.

According to the above-described example, the electronic apparatus 100 may input location information of the subspace in which the user is located and an object presented within the subspace into the trained artificial intelligence model to obtain the probability value for the user behavior pattern. Accordingly, the electronic apparatus 100 may predict the user behavior relatively accurately. For example, if the first user moves within the first subspace in a specific movement direction, the electronic apparatus 100 may identify the predicted user behavior by considering an object disposed in a movement direction of the first user, thereby improving a prediction rate of the electronic apparatus for the user behavior.

FIG. 6 is a flowchart for describing a method for transmitting information about the first content according to an embodiment.

Referring to FIG. 6, according to an embodiment, the operating method may include identifying a first device that is disposed to be relatively closest to the first location among at least one internet of things (IoT) device present in the travel space at operation S610. For example, the first device being relatively closest may mean that a relative distance between the first location and the first device and may be smallest from among a plurality of relative distances between the first location and a plurality of devices (e.g., a plurality of IoT devices) present in the travel space.

For example, the electronic apparatus 100 may obtain information about at least one IoT device present in the travel space from the external device (e.g., the server). For example, the information about at least one IoT device may include identification information of each device and location information of each device within the travel space. In some embodiments, for example, the electronic apparatus 100 may be in a state of being in communication with at least one IoT device, and may obtain information from each of at least one IoT device.

For example, the electronic apparatus 100 may identify the first device that is relatively closest to the first location corresponding to the identified first predicted behavior based on the information about at least one IoT device. As an example, the first predicted behavior may be “cooking food in the kitchen.” In this case, the first content corresponding to the first predicted behavior may be a “cooking recipe”, and the first location corresponding to the first predicted behavior may be the “kitchen.” The electronic apparatus 100 may identify the refrigerator as the first device disposed in the “kitchen” among at least one IoT device. In this case, the refrigerator may include a display.

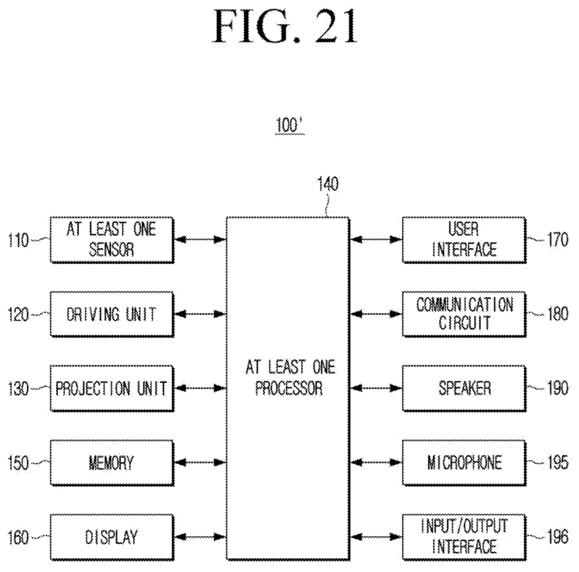

According to an embodiment, the operating method may include transmitting the information about the first content corresponding to the identified first predicted behavior to the first device through the communication circuit (e.g., a communication circuit 180 shown in FIG. 21) at operation S620. For example, the information about the first content may be image information corresponding to the first content.

For example, if the first device is identified, the electronic apparatus 100 may transmit the information about the first content corresponding to the identified first predicted behavior to the first device through the communication circuit. As an example, the first device may be identified as the refrigerator as described above. The electronic apparatus 100 may transmit information about the “cooking recipe” (e.g., at least one of image data or audio data corresponding to the “cooking recipe”) to the refrigerator through the communication circuit. The refrigerator may provide the “cooking recipe” on the display based on the received information.

For example, the electronic apparatus 100 may transmit the information about the first content to the first device using a wired communication circuit or a wireless wired communication circuit.

According to the above-described example, the electronic apparatus 100 may utilize the IoT device within the travel space to provide the content based on the predicted user behavior if it takes a long time to reach a location for providing the content based on the predicted behavior or if it is difficult for the electronic apparatus 100 to move to the location for providing the content. Accordingly, even if it is difficult for the electronic apparatus 100 to provide the content in advance before the user arrives, the electronic apparatus 100 may predict the content in advance and provide the same to the user.

Meanwhile, according to an embodiment, the electronic apparatus 100 may obtain at least one of the context information or the tracking information based on the sensor data obtained using at least one sensor 110 while traveling in the patrol mode within the travel space. In some embodiments, according to an embodiment, the electronic apparatus 100 may obtain the sensor data from at least one IoT device present within the travel space. For example, if the IoT device includes the camera sensor, the electronic apparatus 100 may obtain the sensor data from the IoT device through the communication circuit, and obtain the context information or the tracking information based on the obtained sensor data.

In some embodiments, for example, the electronic apparatus 100 may obtain the context information or the tracking information based on the sensor data obtained from the IoT device and the sensor data obtained using at least one sensor 110, respectively. In some embodiments, for example, the electronic apparatus 100 may obtain the information based on an operation of a device (e.g., a fan) that includes no sensor. For example, if an operation corresponding to turning on the fan is identified, the electronic apparatus may determine that the user is located near the fan and identify an exact location of the user disposed near the fan within the travel space using at least one sensor 110.

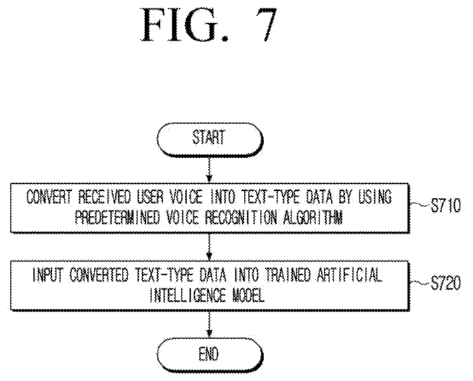

FIG. 7 is a flowchart for describing a method for identifying the predicted user behavior based on the user voice according to an embodiment.

Referring to FIG. 7, according to an embodiment, the operating method may include converting the received user voice into text-type data using a predetermined voice recognition algorithm at operation S710.

For example, the electronic apparatus 100 may include a microphone (e.g., a microphone 195 in FIG. 21). For example, the electronic apparatus 100 may receive the user voice corresponding to the first user through the microphone. For example, if the user voice is received, the electronic apparatus 100 may input the received user voice into the trained artificial intelligence model, thereby updating the probability value for each first user behavior patternat least one first user behavior pattern.

For example, the electronic apparatus 100 may receive a user voice corresponding to “I'm going to watch the soccer game.” The electronic apparatus 100 may convert the user voice into the text-type data using the predetermined voice recognition algorithm (e.g., speech-to-text algorithm).

According to an embodiment, the operating method may include inputting the converted text-type data into the trained artificial intelligence model at operation S720.

For example, the electronic apparatus 100 may input the converted text-type data into the trained artificial intelligence model. For example, the electronic apparatus 100 may input text-type data corresponding to “I'm going to watch the soccer game” into the trained artificial intelligence model.

For example, if the text-type data is input to the trained artificial intelligence model, the electronic apparatus 100 may obtain an updated probability value corresponding to at least one behavior pattern. For example, the updated probability value may reflect the user voice. For example, after the user voice is input, the probability value for a behavior pattern including or corresponding to the predicted behavior of “watching TV” among at least one behavior pattern may increase.

However, the present disclosure is not limited thereto. For example, the electronic apparatus 100 may input audio data corresponding to “I'm going to watch the soccer game” into the trained artificial intelligence model.

Meanwhile, according to an embodiment, various embodiments may be provided in which the electronic apparatus 100 performs an operation corresponding to a user voice signal received through the microphone.

For example, the electronic apparatus 100 may control the display based on the user voice signal received through the microphone. For example, if a user voice signal for displaying content A is received, the electronic apparatus 100 may control the display to display the content A.

As another example, the electronic apparatus 100 may control the external display device connected to the electronic apparatus 100 based on the user voice signal received through the microphone. In detail, the electronic apparatus 100 may generate a control signal for controlling the external display device to perform an operation corresponding to the user voice signal on the external display device, and transmit the generated control signal to the external display device. Here, the electronic apparatus 100 may store a remote control application for controlling the external display device. In addition, the electronic apparatus 100 may transmit the generated control signal to the external display device using at least one of a Bluetooth communication method, a wireless fidelity (Wi-Fi) communication method, or an infrared communication method. For example, if the user voice signal for displaying the content A is received, the electronic apparatus 100 may transmit the control signal to the external display device to display the content A on the external display device. Here, the electronic apparatus 100 may indicate various terminal devices on which remote control applications may be installed, such as smartphones or AI speakers.

As another example, the electronic apparatus 100 may use a remote control device to control the external display device connected to the electronic apparatus 100 based on the user voice signal received through the microphone. In detail, the electronic apparatus 100 may transmit, to the remote control device, the control signal for controlling the external display device to perform the operation corresponding to the user voice signal on the external display device. In addition, the remote control device may transmit the control signal received from the electronic apparatus 100 to the external display device. For example, if the user voice signal for displaying the content A is received, the electronic apparatus 100 may transmit, to the remote control device, a control signal for controlling the content A to be displayed on the external display device, and the remote control device may transmit the received control signal to the external display device.

Meanwhile, the electronic apparatus 100 may receive the user voice signal in various ways.

According to an embodiment, the electronic apparatus 100 may receive the user voice signal through the microphone included in the electronic apparatus 100. For example, the electronic apparatus 100 may include a type of microphone capable of remotely recognizing a voice, and the electronic apparatus 100 may receive the user voice signal through the microphone.

According to another embodiment, the electronic apparatus 100 may receive the user voice signal from the external device including the microphone. Here, the external device may indicate the remote control device, the smartphone, or the like. Here, the received user voice signal may be a digital voice signal, or may be an analog voice signal based on an implementation example. The electronic apparatus 100 may receive the user voice signal via a wireless communication method such as the Bluetooth communication method or the Wi-Fi communication method.

For example, the electronic apparatus 100 may receive the user voice signal from the remote control device that includes the microphone. For example, the remote control device may include the microphone and receive the user voice signal through the microphone. The electronic apparatus may receive the user voice signal from the remote control device via the wireless communication method.

For example, the electronic apparatus 100 may receive the user voice signal from the user terminal or an external IoT device. For example, the electronic apparatus 100 may be in communication with the user terminal (e.g., the smartphone). The user terminal may receive the user voice signal through the microphone. The electronic apparatus 100 may also receive the user voice signal from the user terminal.

In some embodiments, for example, the electronic apparatus 100 may receive the user voice signal from the external IoT device including the microphone. For example, the electronic apparatus 100 may be in communication with the external IoT device (e.g., the TV or the refrigerator). The external IoT device may receive the user voice signal through the microphone. The electronic apparatus 100 may also receive the user voice signal from the external IoT device.

Meanwhile, the electronic apparatus 100 may convert the user voice signal in various ways.

According to an embodiment, the electronic apparatus 100 may obtain text information corresponding to the user voice signal from an external server. In detail, the electronic apparatus 100 may transmit the user voice signal (an audio signal or a digital signal) to the external server. Here, the external server may refer to a voice recognition server. Here, the voice recognition server may convert the user voice signal into the text information using a speech-to-text (STT) function. In addition, the external server may transmit the text information corresponding to the converted user voice signal to the electronic apparatus 100.

According to another embodiment, the electronic apparatus 100 may independently obtain the text information corresponding to the user voice signal. In detail, the electronic apparatus 100 may directly apply the speech-to-text (STT) function to the digital voice signal to convert the same into the text information and transmit the converted text information to the external server.

Meanwhile, the external server may transmit the information to the electronic apparatus 100 in various ways.

According to an embodiment, the external server may transmit the text information corresponding to the user voice signal to the electronic apparatus 100. In detail, the external server may be a server that performs a voice recognition function that converts the user voice signal into the text information.

According to another embodiment, the external server may transmit at least one of the text information corresponding to the user voice signal or search result information corresponding to the text information to the electronic apparatus 100. In detail, the external server may be a server that performs the voice recognition function that converts the user voice signal into the text information and a search result providing function that provides the search result information corresponding to the text information. For example, the external server may be a server that performs both the voice recognition function and the search result providing function. As another example, the external server may perform only the voice recognition function, and a separate server may perform the search result providing function. The external server may transmit the text information to the separate server to obtain a search result and obtain the search result corresponding to the text information from the separate server.

Meanwhile, the electronic apparatus 100 may be in communication with the external device or the external server in various ways.

According to an embodiment, the electronic apparatus 100 may communicate with the external device and the external server using the same communication module. For example, the electronic apparatus 100 may communicate with the external device using a Bluetooth module, and also with the external server using the Bluetooth module.

According to another embodiment, the electronic apparatus 100 may communicate with the external device and the external server using separate communication modules. For example, the electronic apparatus 100 may communicate with the external device using the Bluetooth module and with the external server using an Ethernet modem or a Wi-Fi module.

According to the above-described example, if the user voice is received, the electronic apparatus 100 may identify the predicted user behavior based on the received user voice, thereby increasing the prediction rate for the user behavior.

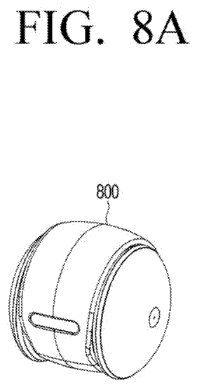

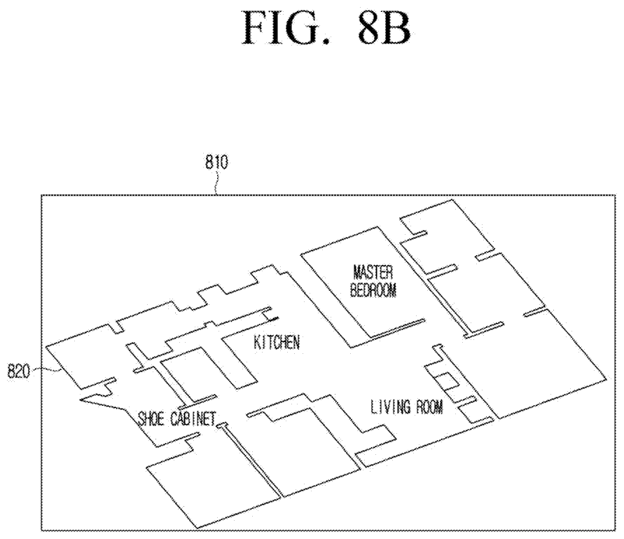

FIG. 8A is a diagram for describing an implementation example of the electronic apparatus according to an embodiment. FIG. 8B is a diagram for describing the map information about the travel space according to an embodiment.

Referring to FIGS. 8A and 8B, according to an embodiment, the electronic apparatus 100 may be implemented as a robot 800. For example, the robot 800 may be a robot that travels along a travel path using wheels, but embodiments are not limited thereto, may be a robot that performs a travel operation using an object different from the wheels. For example, the robot 800 may be equipped with the projection unit 130 capable of displaying content on the projection surface.

According to an embodiment, the robot 800 may store map information 810 corresponding to a travel space 820 to travel within a space. For example, the map information 810 may include identification information for each of at least one subspace within the travel space 820. For example, the map information 810 may include identification information corresponding to each subspace, together with location information within the travel space for each subspace, such as “the living room”, “the shoe cabinet”, “the kitchen”, and “the master bedroom”, included in the travel space 820. For example, the map information 810 may include information regarding a type of the object included in each subspace and a location of each object within the subspace.

For example, the robot 800 may update the map information 810 corresponding to the travel space 820 based on the sensor data obtained using at least one sensor 110. For example, the robot 800 may periodically perform the patrol operation to update the map information 810 corresponding to the travel space 820.

Referring again to FIG. 2, according to an embodiment, the artificial intelligence model may be a model trained using either a reinforcement learning algorithm or a collaborative filtering algorithm.

For example, if the artificial intelligence model is trained using the reinforcement learning algorithm, information used for the training may include time information, location information, activity information, an external factor, or information about a past behavior record.

For example, the time information may include information about the current time, the current day of the week, and a specific event (e.g., whether it is a weekend or a public holiday). For example, the location information may be information about the subspace in which the user is located within the travel space. For example, the activity information may be information about an activity the user is currently performing (e.g., a behavior), which may include a different type of information, such as “watching TV”, “exercising”, “eating”, or “sleeping.” For example, the external factor may include information about the current weather, a current temperature of the travel space, or a lighting state of the travel space. For example, the information about the past behavior record may include the first user history information, for example, a user behavior during the previous one hour, or the frequency information corresponding to each behavior.

For example, if the artificial intelligence model is trained using the reinforcement learning algorithm, the artificial intelligence model may set an initial policy, and then predict the behavior to be performed by the user based on the information used for the training if the corresponding information is obtained. The artificial intelligence model may be trained by a process of changing the policy based on a reward value for the predicted behavior. For example, the policy may be a policy that predicts (or selects) the behavior to be performed by the user based on a Markov decision process (MDP). The Markov decision process (MDP) refers to a mathematical algorithm that models sequential decision problems.

Meanwhile, for example, the artificial intelligence model may be trained based on device usage information of the user. For example, the device usage information may include information about a usage history of the device used by the user (e.g., the user terminal, the TV, the refrigerator, or a dryer). For example, the usage history information may include information about a usage time or a function used by the user. For example, the device usage information may be usage history information of the application on the user terminal. For example, the electronic apparatus 100 may obtain information about the usage history of at least one device present in the home for each time period. For example, the electronic apparatus 100 may collect and analyze a usage pattern of the application on the user terminal corresponding to the first user. In some embodiments, for example, the electronic apparatus 100 may obtain information about the operation time and operation function history of the TV. For example, the artificial intelligence model may be trained to receive the device usage information and predict which application or function the first user frequently uses during a specific time period.

In some embodiments, for example, the artificial intelligence model may be trained using the collaborative filtering algorithm. The collaborative filtering algorithm may be an algorithm that provides personalized recommendations by utilizing user preference data. For example, the artificial intelligence model may be trained using an item-based collaborative filtering algorithm. In the examples described below, the artificial intelligence model may be trained using the item-based collaborative filtering algorithm.

If the artificial intelligence model is trained using the collaborative filtering algorithm, the artificial intelligence model may first perform data collection and matrix generation operations. Here, the data may be data regarding the user behavior performed under the specific condition. For example, the information used for the training may include the time information, the location information, the activity information, the external factor, or the information regarding the past behavior record. For example, the data used for the training may include data regarding the time, the location, the user behavior, or the external factor) and the information regarding the past behavior record.

For example, the artificial intelligence model may generate a user-behavior matrix that represents a relationship between a family member and a behavior. Each row of the matrix may represent an individual family member, and each column may represent a possible behavior. For example, each cell of the matrix may include a value indicating whether a specific user performs a corresponding behavior or quantifying intensity (or frequency) of the behavior.

For example, the artificial intelligence model may perform an operation for measuring a similarity between the behaviors. For example, the artificial intelligence model may measure the similarity between the behaviors based on the generated matrix. For example, a different type of similarity measurement algorithm may be used for similarity measurement, such as cosine similarity, Pearson correlation coefficient, or Jaccard coefficient. For example, the similarity measurement may be performed by considering a frequency at which a specific behavior occurs together with another behavior.

For example, the artificial intelligence model may predict a next behavior of the specific user based on the similarity between the measured behaviors. As an example, the behavior “Father (id) leaving the master bedroom at 8:00 AM on a weekday” may be observed. In this context, “Father (id)” may refer to an object with the identifier “father.” If the above-described behavior is observed, the artificial intelligence model may predict the behavior “Father arriving at the kitchen and drinks water from a water purifier” as a behavior having the highest relative similarity. For example, the artificial intelligence model may update the matrix or the similarity based on whether the predicted behavior matches an actual behavior.

For example, the artificial intelligence model may select any single behavior, or measure each similarity between the plurality of behaviors and output the same.

According to an embodiment, the processor 140 may control a light-emitting unit to enable at least one light-emitting element to emit light if the first behavior pattern having a probability value greater than or equal to a second threshold value (e.g., 50%) is identified among at least one behavior pattern. For example, the electronic apparatus 100 may include the light-emitting unit including at least one light-emitting element. For example, the light-emitting element may be implemented as a light-emitting diode (LED). For example, the processor 140 may control the light-emitting unit to cause at least one light-emitting element to emit light if the probability value corresponding to the first behavior pattern among at least one first user behavior pattern is identified as greater than or equal to the second threshold value and less than the first threshold value (e.g., 80%), without performing a separate content providing operation.

Accordingly, the electronic apparatus 100 may provide the user with information indicating that an operation is to be performed if the user is predicted with a certain level of likelihood to perform the specific behavior.

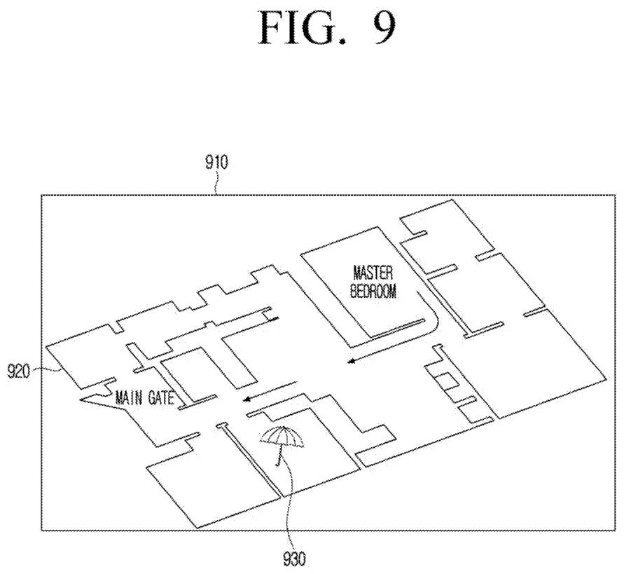

FIG. 9 is a diagram for describing a method for providing the content according to an embodiment.

Referring to FIG. 9, according to an embodiment, the electronic apparatus 100 may identify a behavior of the user leaving the master bedroom within a travel space 920 after being present in the master bedroom. For example, the electronic apparatus 100 may input, into the trained artificial intelligence model, the user tracking information, such as the behavior of the user leaving the master bedroom, together with context information corresponding to the user (e.g., the current time, the specific event, the date, the temperature, or the weather).

For example, map information 910 corresponding to the travel space 920 may also be input into the trained artificial intelligence model. For example, the map information 910 may include location information of an umbrella 930 present in the travel space. However, the present disclosure is not limited thereto, and for example, the map information 910 may include location information of a vehicle key and location information of a wallet.

For example, the electronic apparatus 100 may identify a behavior pattern “the user going out and being away” as a predicted behavior corresponding to the user, based on the probability value corresponding to at least one behavior pattern output from the trained artificial intelligence model.

For example, if “the user going out and being away” is identified as the predicted behavior, the electronic apparatus 100 may move to the living room and display “content including the weather information” on the projection surface (e.g., a living room wall) present in the living room using the projection unit 130. In this case, if a current rainy situation (e.g., a situation where a probability of precipitation is 50% or higher) is identified based on the context information, the electronic apparatus 100 may also display content including the location information of the umbrella 930. For example, the electronic apparatus 100 may provide the location information of the umbrella 930 within the travel space, or provide a notification to allow the user to recognize the location of the umbrella 930.

In some embodiments, for example, the electronic apparatus 100 may display content including the location information of the vehicle key and the location information of the wallet using the projection unit 130 if “the user going out and being away” is identified as the predicted behavior.

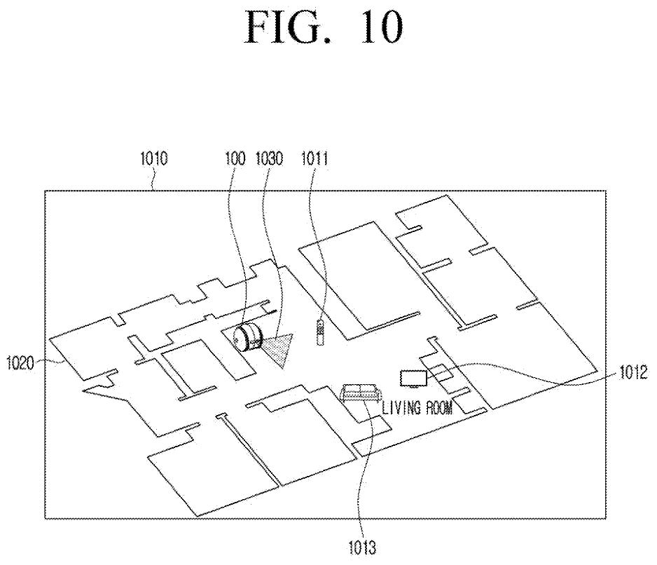

FIG. 10 is a diagram for describing a method for providing content according to an embodiment.

Referring to FIG. 10, according to an embodiment, the electronic apparatus 100 may identify a behavior of the user sitting on a sofa 1013 disposed in the living room and watching a TV 1012. For example, the electronic apparatus 100 may identify the tracking information including a user location within a travel space 1020 (e.g., a user location within the living room) and a user head orientation based on the sensor data obtained using at least one sensor 110. For example, the electronic apparatus 100 may obtain location information of the sofa 1013, location information of a remote control 1011, and location information of the TV 1012, respectively, based on map information 1010.

For example, the electronic apparatus 100 may obtain the probability value for each of at least one user behavior pattern by inputting the identified tracking information, map information 1010, and context information into the trained artificial intelligence model.

For example, the electronic apparatus 100 may identify a “TV control operation” as the predicted user behavior. For example, the electronic apparatus 100 may perform an operation corresponding to turning on the TV 1012 and an operation for projecting a location of the remote control 1011 as content corresponding to the identified “TV control operation.” For example, the electronic apparatus 100 may transmit a control signal corresponding to turning on the TV 1012 to the TV 1012 through the communication circuit. In some embodiments, the electronic apparatus 100 may provide a notification 1030 to enable the user to recognize the location of the remote control 1011 within the travel space 1020.

In some embodiments, if the user voice is received, the electronic apparatus 100 may input the user voice into the trained artificial intelligence model. For example, if a user voice, “Where is the remote control?” is received, the electronic apparatus 100 may input the received user voice into the trained artificial intelligence model. The electronic apparatus 100 may perform an operation corresponding to turning on the TV 1012 and the operation for projecting the location of the remote control 1011.

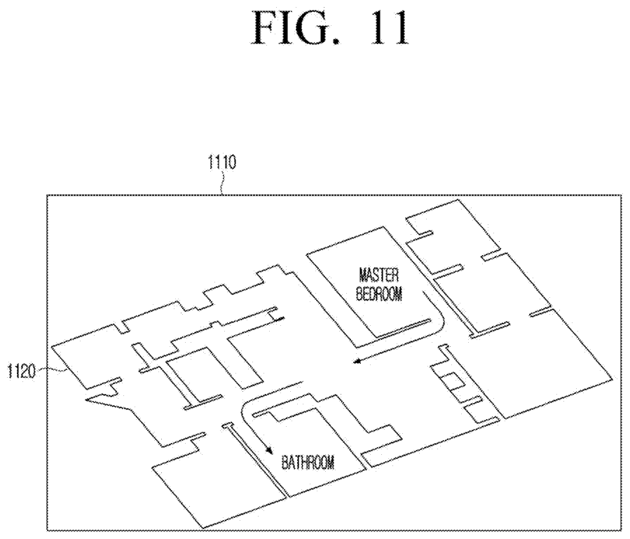

FIG. 11 is a diagram for describing a method for providing content according to an embodiment.

Referring to FIG. 11, according to an embodiment, the electronic apparatus 100 may identify the behavior of the user leaving the master bedroom at 11:00 PM after being present in the master bedroom. For example, the electronic apparatus 100 may input the user tracking information, such as the behavior of the user leaving the master bedroom, together with the user context information (e.g., the current time, the specific event, the date, the temperature, or the weather) into the trained artificial intelligence model.

For example, the map information 910 corresponding to the travel space 920 may also be input into the trained artificial intelligence model. For example, the map information 910 may include location information of the plurality of subspaces (e.g., the master bedroom or the bathroom) present within the travel space.

For example, the electronic apparatus 100 may perform a preliminary operation by controlling the light-emitting element included in the electronic apparatus 100 to emit light if a probability value corresponding to “moving to the bathroom” among the user behavior patterns is identified as exceeding the second threshold value (e.g., 50%) after “the user behavior of leaving the master bedroom” is input into the trained artificial intelligence model.

For example, the electronic apparatus 100 may perform a user tracking operation based on the sensor data obtained using at least one sensor 110 while performing the preliminary operation.

For example, the electronic apparatus 100 may identify the user as moving to the living room while performing the preliminary operation and the tracking operation. The electronic apparatus 100 may input the tracking information associated with a user movement to the living room into the trained artificial intelligence model, thereby updating the probability value for the user behavior pattern.

For example, as the probability value is updated, if the probability value corresponding to “moving to the bathroom” is identified as exceeding the first threshold value (e.g., 80%), the electronic apparatus 100 may control the lighting to operate on a path from the living room to the bathroom before the user arrives at the bathroom. In some embodiments, the electronic apparatus 100 may control the light-emitting element to illuminate a path of the user moving to the bathroom. In this case, the electronic apparatus 100 may control the lighting or the light-emitting element to operate the lighting at a predetermined brightness if another user (or the family member) is present on the path to the bathroom or in the living room, based on the sensor data obtained using at least one sensor 110.

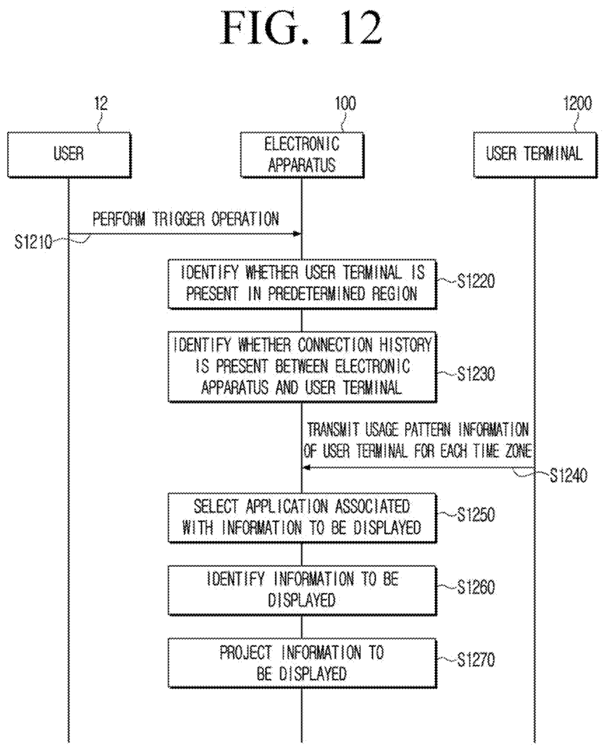

FIG. 12 is a flowchart for describing a method for providing information corresponding to the application according to an embodiment.

Referring to FIG. 12, according to an embodiment, the method for operating the electronic apparatus 100 may include identifying whether a user 12 performs a trigger operation at operation S1210. For example, the trigger operation may be a trigger operation for providing the information corresponding to the application. For example, the information corresponding to the application may be information about content associated with the application. According to embodiments, the information corresponding to the application may be referred to as, for example, application information corresponding to the application.

For example, the electronic apparatus 100 can identify the trigger operation based on the identified predicted behavior. For example, if a behavior for providing the information corresponding to the application (e.g., moving to the location of the electronic apparatus 100 or finding a user terminal 1200) is predicted, the electronic apparatus 100 may identify the trigger operation based thereon. In some embodiments, for example, the electronic apparatus 100 may identify the trigger operation based on a user input for outputting the information corresponding to the application. In some embodiments, for example, if the user 12 approaches a predetermined region, the electronic apparatus 100 may identify the user approach as the trigger operation. This configuration is described below.

According to an embodiment, the method for operating the electronic apparatus 100 may include identifying whether the user terminal 1200 is present in a predetermined region at operation S1220. For example, the electronic apparatus 100 may determine whether the user terminal 1200 is present in the predetermined region within the travel space if the user 12 is identified as performing the trigger operation at operation S1210. For example, the electronic apparatus 100 may determine whether the user terminal 1200 is present in the predetermined region based on location information (e.g., global pointing system (GPS) information) of the user terminal 1200. However, the present disclosure is not limited thereto, and for example, the electronic apparatus 100 may determine whether the user terminal 1200 is present in the predetermined region even if the user 12 does not perform the trigger operation.

According to an embodiment, the method for operating the electronic apparatus 100 may include identifying whether a connection history is present between the electronic apparatus 100 and the user terminal 1200 at operation S1230. For example, the electronic apparatus 100 may determine whether the connection history is present between the electronic apparatus 100 and the user terminal 1200 based on identification information of the user terminal 1200 present in the predetermined region.

According to an embodiment, a method for operating the user terminal 1200 may include transmitting usage pattern information of the user terminal 1200 for each time period to the electronic apparatus 100 at operation S1240. For example, the usage pattern information of the user terminal 1200 for each time period may include device usage information of the user 12 corresponding to the user terminal 1200. For example, the device usage information may include usage history information of the user terminal 1200. For example, the usage history information may include information about functions used by the user 12 for each usage time or time period. For example, the device usage information may be usage history information of a specific application on the user terminal 1200.

For example, the electronic apparatus 100 may obtain the usage pattern information of the user terminal 1200 for each time period, such as the device usage information, from the user terminal 1200.

According to an embodiment, the method for operating the electronic apparatus 100 may include selecting an application associated with information to be displayed at operation S1250. For example, the information to be displayed may be the information corresponding to the application. For example, if the usage pattern information is received, the electronic apparatus 100 may select the application associated with the information to be displayed during a current time period based on the received information. This configuration is described below.

According to an embodiment, the method for operating the electronic apparatus 100 may include identifying the information to be displayed at operation S1260 and projecting the information to be displayed at operation S1270. For example, if the application is identified, the electronic apparatus 100 may identify the information to be displayed based on at least one of the tracking information or the context information of the user 12. For example, the electronic apparatus 100 may provide the identified information using the projection unit.

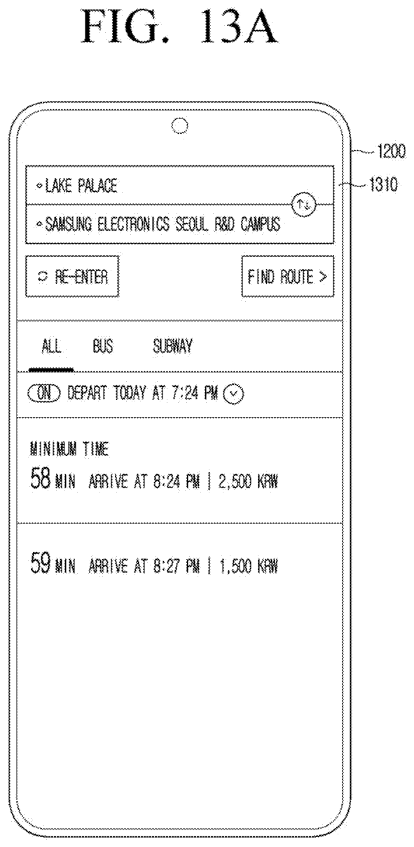

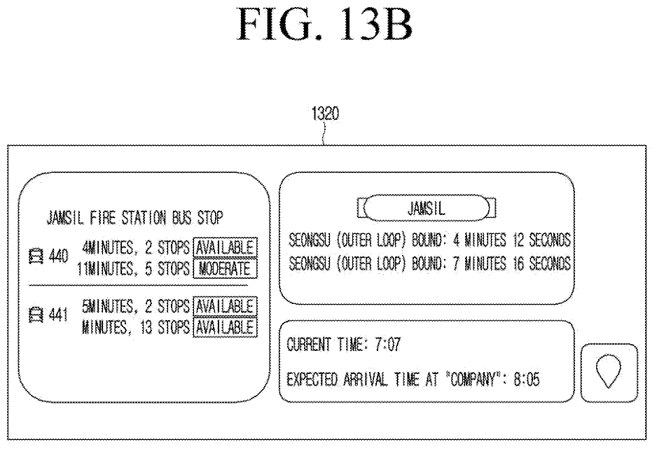

FIGS. 13A and 13B are diagrams for describing a method for providing information corresponding to an application according to an embodiment.

Referring to FIGS. 13A and 13B, according to an embodiment, the electronic apparatus 100 may provide information 1320 corresponding to the application using the projection unit based on usage pattern information. For example, the information 1320 corresponding to the application may be user interface (UI) type information.

For example, the electronic apparatus 100 may determine whether the user terminal 1200 is present in the predetermined region from the electronic apparatus 100 if a trigger operation for providing the information 1320 corresponding to the application is identified. For example, the electronic apparatus 100 may determine whether the connection history is present between the user terminal 1200 and the electronic apparatus 100 if the user terminal 1200 is present in the predetermined region. For example, if the connection history is present, the electronic apparatus 100 may obtain the usage pattern information of the user terminal 1200 for each time period from the user terminal 1200.

As an example the current time may be between 7:00 AM and 8:00 AM on a weekday. The electronic apparatus 100 may receive the usage pattern information of the user terminal 1200 for each time period from the user terminal 1200 through the communication circuit. For example, the usage pattern information may include “the user mainly uses a public transportation information providing application during a time period between 7:00 AM and 8:00 AM on a weekday and “the user mainly searches for a first movement route through the public transportation information providing application during the time period between 7:00 AM and 8:00 AM on a weekday.”

For example, the electronic apparatus 100 may select “the public transportation information providing application” based on the usage pattern information. For example, the electronic apparatus 100 may identify information to be provided to the user through the public transportation information providing application based on the usage pattern information and provide the information using the projection unit.

For example, as shown in FIG. 13B, the electronic apparatus 100 may provide a different type of information corresponding to the public transportation information providing application. For example, the electronic apparatus 100 may selectively provide only information about an expected arrival time of a bus used by the user based on GPS information of the user terminal 1200. In some embodiments, for example, as shown on the right side of FIG. 13B, the electronic apparatus 100 may provide information 1320 in which an icon corresponding to the public transportation information providing application is disposed. If a user input for the disposed icon is received, the electronic apparatus 100 may provide information 1310 regarding “a search result for the first movement route through the public transportation information providing application” using the projection unit. In some embodiments, for example, the electronic apparatus 100 may provide at least one of information about the bus used by the user, information about a subway, current time information, and expected arrival time information using the projection unit.

For example, the electronic apparatus 100 may obtain data on a user movement route corresponding to a weekday or a holiday based on the GPS information of the user terminal 1200. For example, the electronic apparatus 100 may identify the predicted user behavior based on the obtained data on the movement route. For example, the electronic apparatus 100 may provide content to the user based on the identified predicted behavior.

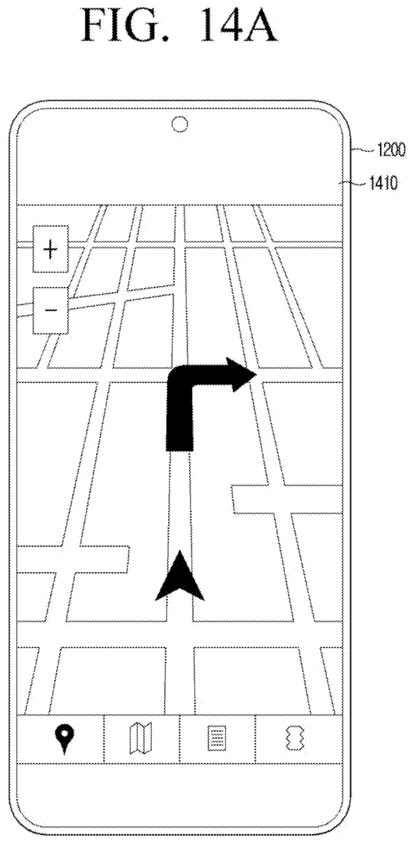

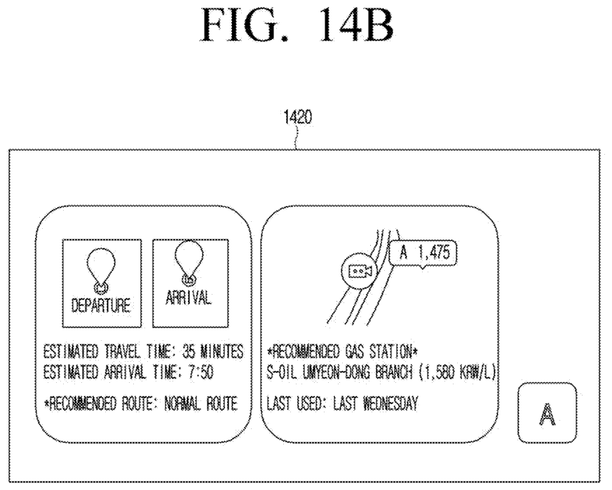

FIGS. 14A and 14B are diagrams for describing a method for providing information corresponding to an application according to an embodiment

Referring to FIGS. 14A and 14B, according to an embodiment, the electronic apparatus 100 may provide information 1420 corresponding to an application using the projection unit based on usage pattern information. For example, the information 1420 corresponding to the application may be user interface (UI) type information.

For example, the electronic apparatus 100 may determine whether the user terminal 1200 is present in the predetermined region from the electronic apparatus 100 if a trigger operation for providing the information 1420 corresponding to the application is identified. For example, the electronic apparatus 100 may determine whether the connection history is present between the user terminal 1200 and the electronic apparatus 100 if the user terminal 1200 is present in the predetermined region. For example, if the connection history is present, the electronic apparatus 100 may obtain the usage pattern information of the user terminal 1200 for each time period from the user terminal 1200.

As an example, the current time may be between 7:00 AM and 8:00 AM on a weekday. The electronic apparatus 100 may receive the usage pattern information of the user terminal 1200 for each time period from the user terminal 1200 through the communication circuit. For example, the usage pattern information may include “the user mainly uses a navigation application between 7:00 AM and 8:00 AM on a weekday” and “the user mainly searches for a second movement route through the navigation application between 7:00 AM and 8:00 AM on a weekday.”

For example, the electronic apparatus 100 may select the “navigation application” based on the usage pattern information. For example, the electronic apparatus 100 may identify information to be provided to the user through the navigation application based on the usage pattern information and provide the information using the projection unit.

For example, as shown in FIG. 14B, the electronic apparatus 100 may provide a different type of information corresponding to the navigation application. For example, the electronic apparatus 100 may process and provide information about an estimated time to a destination, an expected arrival time, and a recommended route. In some embodiments, for example, the electronic apparatus 100 may identify information about a gas station frequently used by the user based on the GPS information of the user terminal 1200. The electronic apparatus 100 may provide the information about the gas station frequently used by the user. In this case, as shown in FIG. 14B, the electronic apparatus 100 may provide the information about the recommended route and the information about the gas station as separate information. For example, as shown on the right side of FIG. 14B, the electronic apparatus 100 may provide the information 1420 in which an icon corresponding to the navigation application is disposed. If a user input for the disposed icon is received, the electronic apparatus 100 may provide information 1410 about a search result for the second movement route through the navigation application using the projection unit.

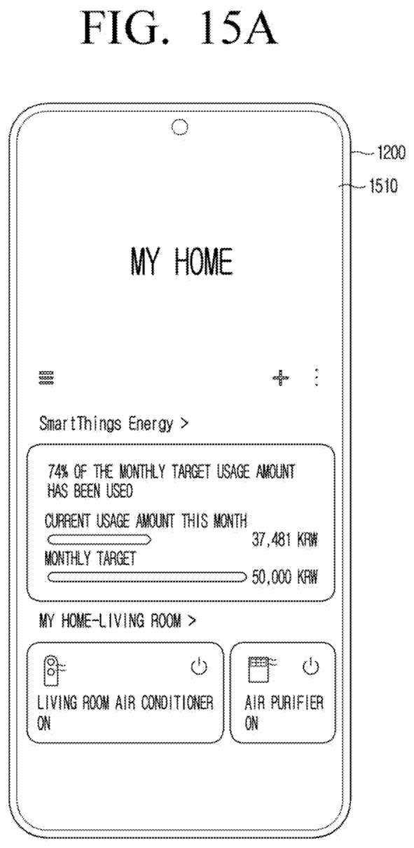

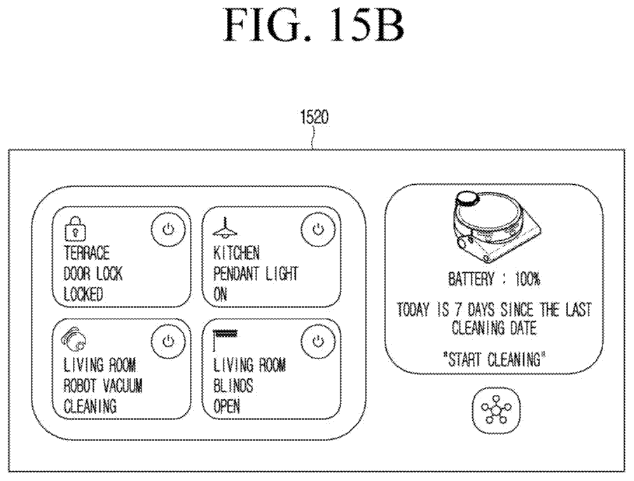

FIGS. 15A and 15B are diagrams for describing a method for providing information corresponding to an application according to an embodiment.

Referring to FIGS. 15A and 15B, according to an embodiment, the electronic apparatus 100 may provide information 1520 corresponding to an application using the projection unit based on usage pattern information. For example, the information 1520 corresponding to the application may be user interface (UI) type information.

For example, the electronic apparatus 100 may determine whether the user terminal 1200 is present in the predetermined region from the electronic apparatus 100 if a trigger operation for providing the information 1500 corresponding to the application is identified. For example, the electronic apparatus 100 may determine whether the connection history is present between the user terminal 1200 and the electronic apparatus 100 if the user terminal 1200 is present in the predetermined region. For example, if the connection history is present, the electronic apparatus 100 may obtain the usage pattern information of the user terminal 1200 for each time period from the user terminal 1200.

As an example, the current time may be between 7:00 PM and 8:00 PM on a weekday. The electronic apparatus 100 may receive the usage pattern information of the user terminal 1200 for each time period from the user terminal 1200 through the communication circuit. For example, the usage pattern information may include “the user mainly uses an internet of things (IoT) device manipulation application present in the home between 7:00 PM and 8:00 PM on a weekday” and “the user mainly manipulates the first device and the second device through the IoT device manipulation application between 7:00 PM and 8:00 PM on a weekday.”

For example, the electronic apparatus 100 may select the “IoT device manipulation application” based on the usage pattern information. For example, the electronic apparatus 100 may identify information to be provided to the user through the IoT device manipulation application based on the usage pattern information and provide the information using the projection unit.

For example, as shown in FIG. 15B, the electronic apparatus 100 may provide a different type of information corresponding to the IoT device manipulation application. For example, the electronic apparatus 100 may provide user interface (UI) information for manipulating at least one IoT device mainly used by the user.

For example, the electronic apparatus 100 may obtain information about each of at least one IoT device from the user terminal 1200. For example, based on the obtained information, the electronic apparatus 100 may determine that a predetermined time elapses from a cleaning date of a robot vacuum cleaner among at least one IoT device, and may provide information related thereto using the projection unit. However, the present disclosure is not limited thereto, and based on the information about each of at least one IoT device and usage pattern information of the IoT device of the user, the electronic apparatus 100 may identify information associated with the IoT device most suitable for the user during a specific time period, and provide the information using the projection unit.

In some embodiments, for example, as shown in the lower right portion of FIG. 15B, the electronic apparatus 100 may provide the information 1520 regarding a disposed icon corresponding to the IoT device manipulation application. If a user input for the disposed icon is received, the electronic apparatus 100 may provide information 1510 regarding a “state of each of at least one IoT device provided through the IoT device manipulation application” using the projection unit.

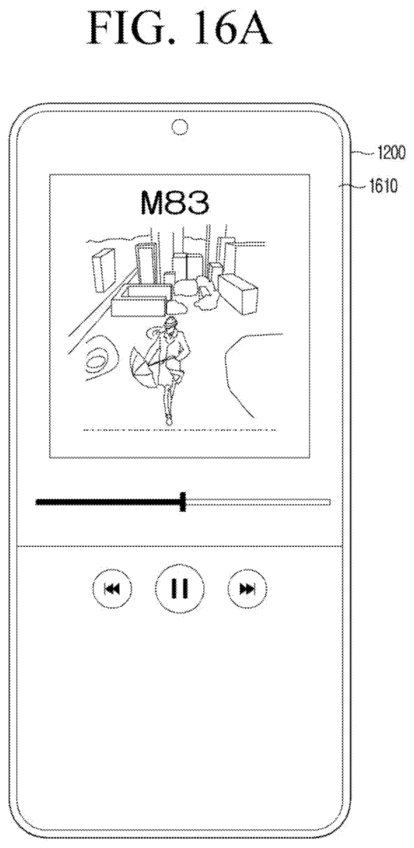

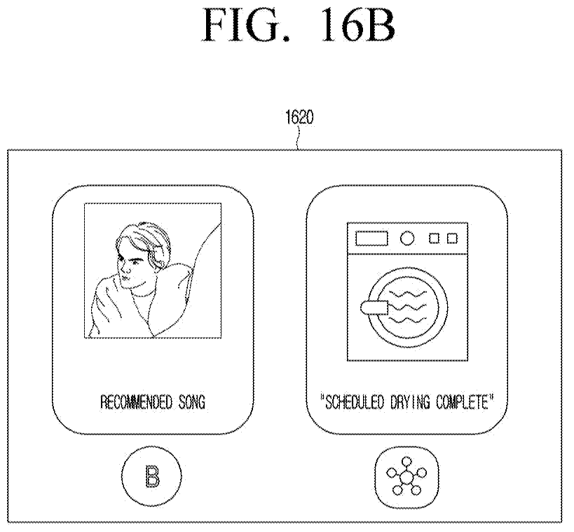

FIG. 16A and FIG. 16B is a diagram for describing a method for providing information 1620 corresponding to an application according to an embodiment.

Referring to FIGS. 16A and 16B, according to an embodiment, the electronic apparatus 100 may provide a plurality of information 1620 corresponding to the application using the projection unit based on usage pattern information.

As an example, the current time may be between 7:00 PM and 8:00 PM on a weekday. The electronic apparatus 100 may receive the usage pattern information of the user terminal 1200 for each time period from the user terminal 1200 through the communication circuit. For example, the usage pattern information may include “the user mainly uses an internet of things (IoT) device manipulation application present in the home between 7:00 PM and 8:00 PM on a weekday” and “the user mainly uses a music playback application between 7:00 PM and 8:00 PM on a weekday.”

For example, the electronic apparatus 100 may select “the IoT device manipulation application” and “the music playback application” based on the usage pattern information. For example, the electronic apparatus 100 may identify information to be provided to the user through the IoT device manipulation application and the information to be provided through the music playback application based on the usage pattern information, and provide the information using the projection unit.

For example, as shown on the right side of FIG. 16B, the electronic apparatus 100 may provide a different type of information corresponding to the IoT device manipulation application. For example, the electronic apparatus 100 may provide state information of at least one IoT device. In some embodiments, for example, as shown on the left side of FIG. 16B, the electronic apparatus 100 may provide information associated with the music playback application. For example, the electronic apparatus 100 may provide information about recommended music through the music playback application using the projection unit.

In some embodiments, for example, as shown in the lower left portion of FIG. 16B, the electronic apparatus 100 may provide the information 1620 in which an icon corresponding to the music playback application is disposed. If a user input for the disposed icon is received, the electronic apparatus 100 may provide a UI 1610 corresponding to the music playback application using the projection unit.

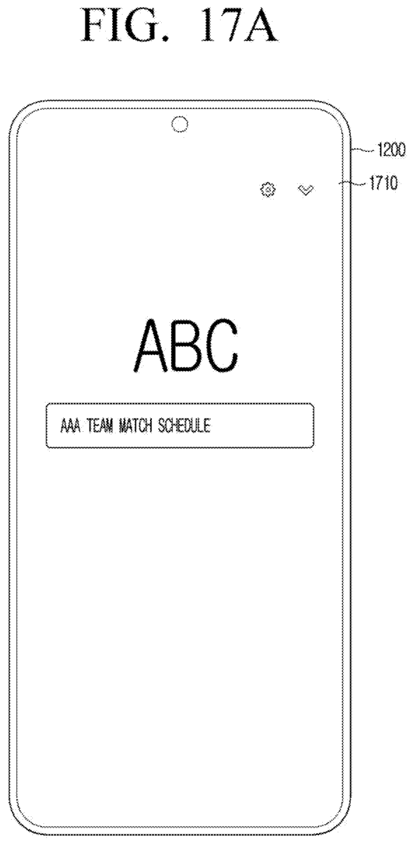

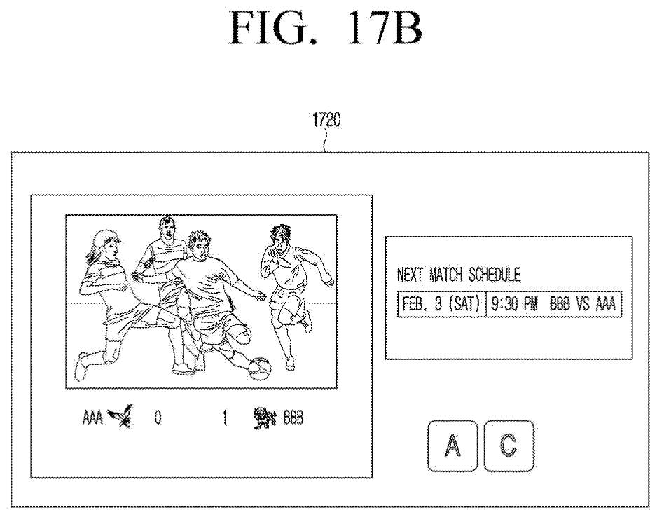

FIGS. 17A and 17B are diagrams for describing a method for providing information corresponding to an application according to an embodiment.

Referring to FIGS. 17A and 17B, according to an embodiment, the electronic apparatus may provide information 1720 corresponding to an application using the projection unit based on usage pattern information. For example, the usage pattern information may include information about a search history obtained through a search application.

For example, the electronic apparatus may receive the usage pattern information of the user terminal for each time period from the user terminal through the communication circuit. For example, the usage pattern information may include “the user searches for a match schedule of an “AAA” soccer club through the search application” and “the user has yet to obtain information about a match result of the “AAA” soccer club.”

For example, the electronic apparatus may select the “search application” based on the usage pattern information. For example, the electronic apparatus may identify information to be provided to the user (e.g., information about the match result of the “AAA” soccer club and a next match schedule of the “AAA” soccer club) through the search application based on the usage pattern information, and provide the information through the projection unit.

For example, as shown in the lower right portion of FIG. 17B, the electronic apparatus may provide the information 1720 in which an icon corresponding to the search application and an icon corresponding to an application associated with the search result are disposed. For example, the application associated with the search result may be an application providing an image of game highlights of the “AAA” soccer club. For example, if a user input for the icon corresponding to the search application is received, the electronic apparatus may provide “a UI 1710 corresponding to the search application” using the projection unit.

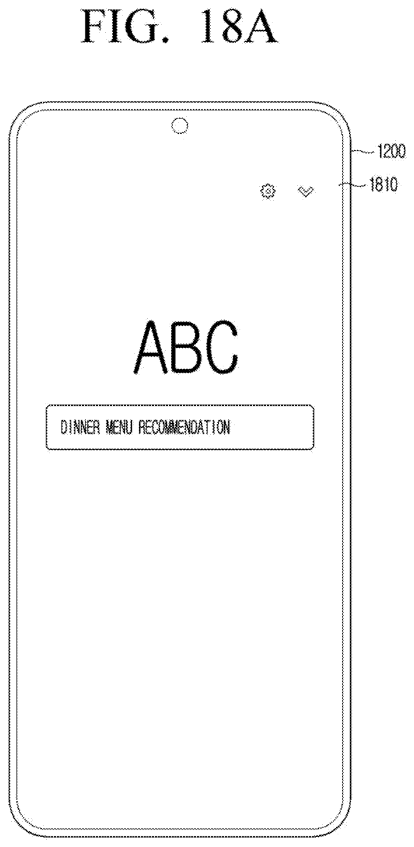

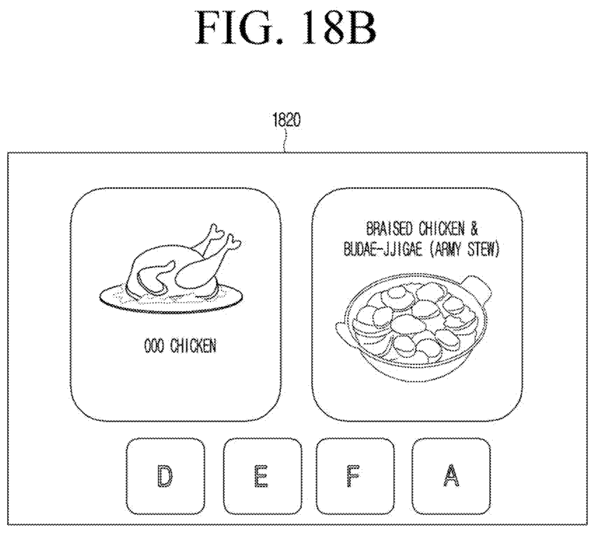

FIGS. 18A and 18B are diagrams for describing a method for providing information corresponding to an application according to an embodiment.

Referring to FIGS. 18A and 18B, according to an embodiment, the electronic apparatus may provide information 1820 corresponding to an application using the projection unit based on usage pattern information. For example, the usage pattern information may include information about search history through the search application.

For example, the electronic apparatus may receive the usage pattern information of the user terminal for each time period from the user terminal through the communication circuit. For example, the usage pattern information may include that “the user mainly searches for a meal menu through a search application between 7:00 PM and 8:00 PM on a weekday” and “no record of food orders through a delivery application is present between 7:00 PM and 8:00 PM today.”

For example, the electronic apparatus may identify “the search application” and “the delivery application” based on the usage pattern information. For example, the electronic apparatus may provide information about the meal menu that the user mainly searches for (e.g., UIs indicating food from brand “B” and food from brand “C”) using the projection unit based on the usage pattern information.

For example, as shown at the bottom of FIG. 18B, the electronic apparatus may provide the information 1820 in which an icon corresponding to the search application and an icon corresponding to an application associated with the search result are disposed. For example, the application associated with the search result may be at least one delivery application. For example, if a user input for the icon corresponding to the search application is received, the electronic apparatus may provide “a UI corresponding to a search application 1810” using the projection unit.

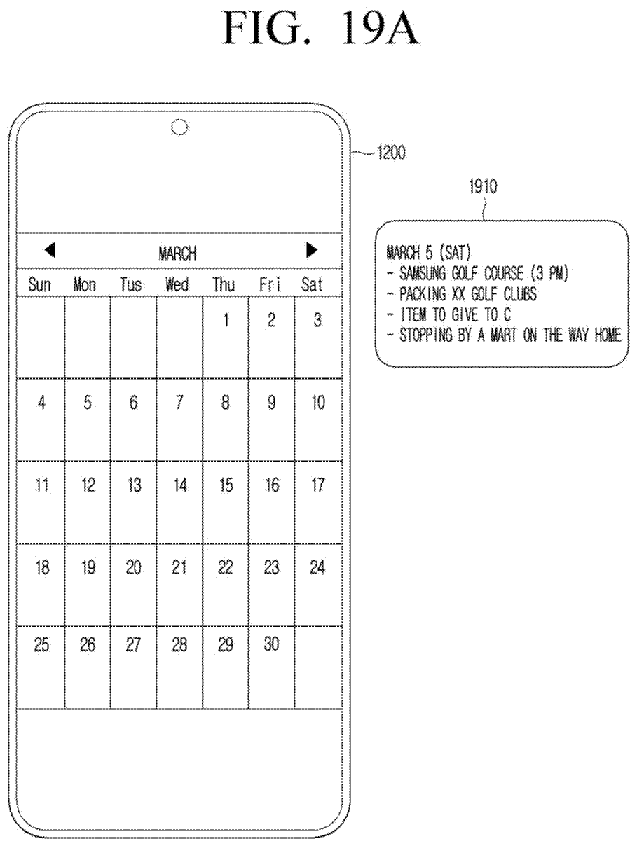

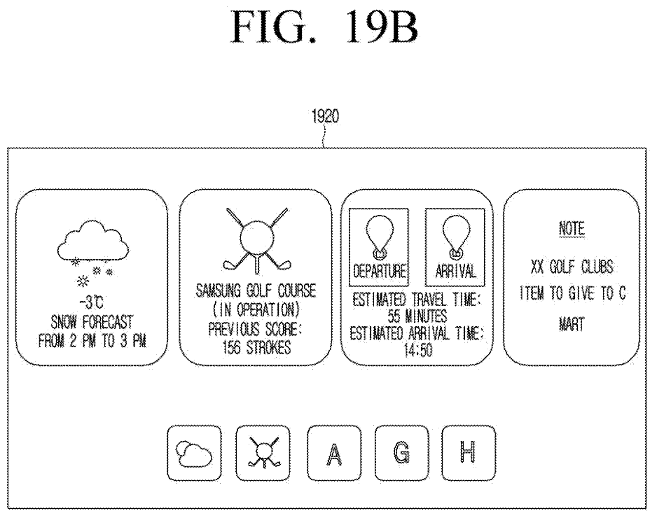

FIGS. 19A and 19B are diagrams for describing a method for providing information 1920 corresponding to an application according to an embodiment.

Referring to FIGS. 19A and 19B, according to an embodiment, the electronic apparatus may provide the information 1920 corresponding to the application using the projection unit based on usage pattern information. For example, the usage pattern information may include information about a schedule included in a schedule recording application.

For example, the electronic apparatus may receive the usage pattern information of the user terminal for each time period from the user terminal through the communication circuit. For example, the usage pattern information may include information 1910 about the user schedule included in the schedule recording application. For example, the processor may identify information about a date (e.g., a weekend) after a predetermined time from the current date. For example, the schedule information may include “golf rounding at 3:00 PM”, “packing golf clubs”, “giving an item to C”, and “stopping by a market on the way home.”

For example, the electronic apparatus may identify a “weather application”, a “golf reservation application”, a “navigation application”, and a “note application” based on the usage pattern information. For example, the electronic apparatus may identify, for each application, information corresponding to a date after the predetermined time based on the usage pattern information. For example, the electronic apparatus may provide information including a UI corresponding to the identified information. For example, the electronic apparatus may provide the weather information for a weekend. In some embodiments, the electronic apparatus may provide information regarding a score of a previous golf round. In some embodiments, the electronic apparatus may provide information regarding at least one of an expected travel time to a golf course and an expected arrival time. In some embodiments, the electronic apparatus may provide a note corresponding to the date after the predetermined time.

For example, as shown at the bottom of FIG. 19B, the electronic apparatus may provide the information 1920 in which an icon corresponding to at least one application associated with the schedule information is disposed. For example, at least one application may include the weather application, the golf reservation application, the navigation application, or the schedule recording application, but embodiments are not limited thereto.

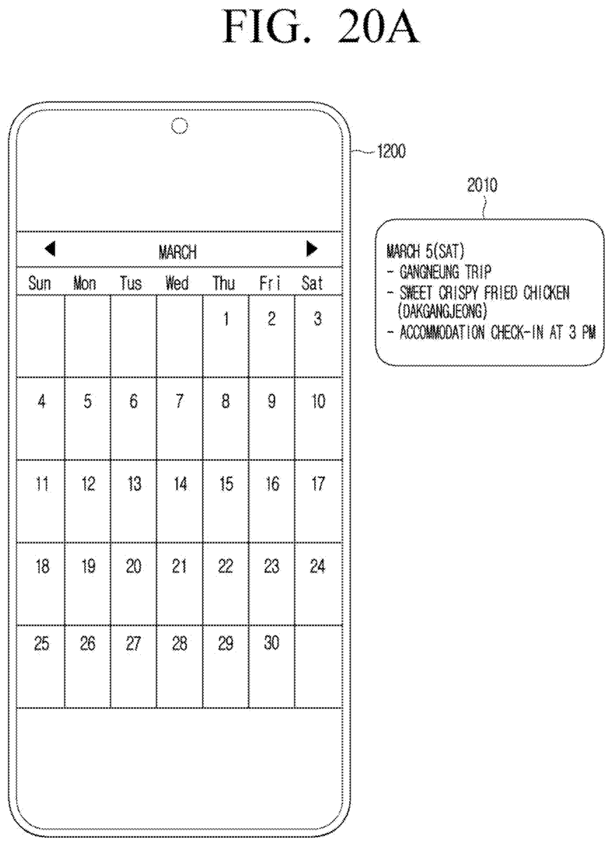

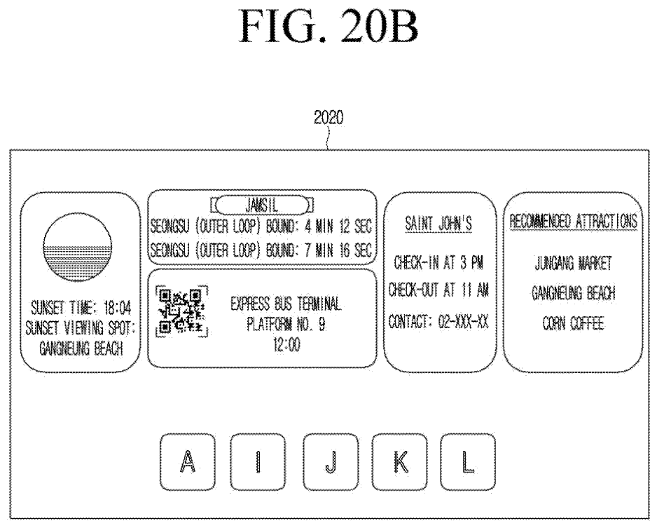

FIGS. 20A and 20B are diagrams for describing a method for providing information corresponding to an application according to an embodiment.

Referring to FIGS. 20A and 20B, according to an embodiment, the electronic apparatus may provide information 2020 corresponding to an application using the projection unit based on usage pattern information. For example, the usage pattern information may include information about a schedule included in the schedule recording application.

For example, the electronic apparatus may receive the usage pattern information of the user terminal for each time period from the user terminal through the communication circuit. For example, the usage pattern information may include information 2010 about a user schedule included in the schedule recording application. For example, the processor may identify information about a date (e.g., a weekend) after a predetermined time from the current date. For example, the schedule information 2010 may include “trip to Gangneung”, “visit to restaurant A”, and “check-in time at an accommodation.”

For example, the electronic apparatus may identify “the weather application”, “the public transportation information providing application”, “an accommodation reservation application”, or “the note application” based on the usage pattern information. For example, the electronic apparatus may identify, for each application, information corresponding to a date after a predetermined time based on the usage pattern information.

For example, the electronic apparatus may provide information including a UI corresponding to the identified information. For example, the electronic apparatus may provide weather information for Gangneung, including a sunset time and a sunset spot. In some embodiments, the electronic apparatus may provide information about public transportation or bus stops. In some embodiments, the electronic apparatus may provide information about accommodations, including check-in and check-out times. In some embodiments, the electronic apparatus may provide a note about a recommended restaurant.

For example, as shown at the bottom of FIG. 20B, the electronic apparatus may provide information 2020 in which an icon corresponding to at least one application associated with the schedule information is disposed. For example, at least one application may include the weather application, the search application, the public transportation information providing application, the accommodation reservation application, or the schedule recording application, but embodiments are not limited thereto.

FIG. 21 is a block diagram showing specific components included in an electronic apparatus according to an embodiment.

Referring to FIG. 21, an electronic apparatus 100′ may include at least one sensor 110, the driving unit 120, the projection unit 130, at least one processor 140, the memory 150, a display 160, a user interface 170, the communication circuit 180, a speaker 190, the microphone 195 and an input/output interface 196. Detailed descriptions of the components shown in FIG. 21 that overlap with those shown in FIG. 2 are omitted.

The display 160 may be implemented as a display including a self-luminous element, or a display including a non-luminous element and a backlight. For example, the display may be implemented as various types of displays such as a liquid crystal display (LCD), an organic light emitting diode (OLED) display, a light-emitting diode (LED) display, a micro LED display, a mini LED display, a plasma display panel (PDP), a quantum dot (QD) display, and a quantum dot light-emitting diode (QLED) display. The display 160 may also include a driving circuit, a backlight unit, and the like, which may be implemented in a form such as an amorphous silicon thin film transistor (a-si TFT), a low temperature poly silicon (LTPS) TFT, or an organic TFT (OTFT). Meanwhile, the display 160 may be implemented as a touchscreen combined with a touch sensor, a flexible display, a rollable display, a three-dimensional (3D) display, a display in which a plurality of display modules are physically connected to each other, or the like. The processor 140 may control the display 160 to output an output image obtained according to the various embodiments described above. Here, the output image may be a high-resolution image of 4K or 8K or higher. The output image may also be a game image according to an embodiment.

According to an embodiment, the display 160 may include a plurality of haptic elements. The haptic element may be implemented as a motor for providing haptic feedback (e.g., vibration feedback) to the user, but embodiments are not limited thereto. For example, the display 160 may include a predetermined number of haptic elements. For example, the display 160 may include the predetermined number of haptic elements corresponding to a predetermined number of sub-regions of the display, is not limited thereto, and include a different number of haptic elements from the plurality of sub-regions corresponding to the display.

The user interface 170 is a component to enable the electronic apparatus 100′ to interact with the user. For example, the user interface 170 may include at least one of a touch sensor, a motion sensor, a button, a jog dial, a switch, a microphone, or a speaker, but embodiments are not limited thereto.

The communication circuit 180 may input and output various types of data. For example, the communication circuit 180 may transmit and receive various types of data to and from the external device (e.g., a source device), an external storage medium (e.g., a universal serial bus (USB) memory), the external server (e.g., a web hard) using communication methods such as access point (AP)-based wireless fidelity (Wi-Fi, wireless local area network (LAN)), Bluetooth, Zigbee, wired/wireless local area network (LAN), wide area network (WAN), Ethernet, IEEE 1394, high definition multimedia interface (HDMI), universal serial bus (USB), mobile high-definition link (MHL), audio engineering society/European broadcasting union (AES/EBU) communication, optical communication, or coaxial communication.

For example, the communication circuit 180 may include a Bluetooth low energy (BLE) module. The BLE refers to a Bluetooth technology that enables transmission and reception of low-power and low-capacity data in a 2.4 gigahertz (GHz) frequency band having a range of about 10 m. However, the present disclosure is not limited thereto, and the communication circuit 180 may include a Wi-Fi communication module. That is, the communication circuit 180 may include at least one of the Bluetooth low energy (BLE) module or the Wi-Fi communication module.

According to an embodiment, the speaker 190 may include a tweeter for reproducing high-frequency sounds, a midrange for reproducing medium-frequency sounds, a woofer for reproducing low-frequency sounds, a subwoofer for reproducing ultra-low-frequency sounds, an enclosure for controlling resonance, a crossover network for dividing a frequency of an electric signal input into the speaker into bands, or the like.

According to an embodiment, the speaker 190 may output an audio signal to the outside of the electronic apparatus 100′. The speaker 190 may output multimedia playback, recording playback, various notification sounds, voice messages, or the like. The electronic apparatus 100′ may include an audio output device such as the speaker 190, and may include an output device such as an audio output terminal. In particular, the speaker 190 may provide obtained information, information processed and produced based on the obtained information, a response result to a user voice, or an operation result, or the like in a voice form.

The microphone 195 may refer to a module that obtains sound and converts the same into the electric signal, and may be implemented as a condenser microphone, a ribbon microphone, a moving coil microphone, a piezoelectric element microphone, a carbon microphone, or a micro electro mechanical system (MEMS) microphone. In addition, the microphone 195 may be implemented in an omnidirectional, bidirectional, unidirectional, subcardioid, supercardioid, hypercardioid manner. According to an embodiment, the electronic apparatus 100′ may include the microphone 195 and an inner microphone, and the microphone 195 may be a microphone positioned relatively outside a body. In an example, the electronic apparatus 100′ may obtain an audio signal including external noise through the microphone 195. According to an embodiment, the microphone 195 may be disposed in a direction opposite to a direction in which the speaker 190 emits sound.

An input/output interface 196 may be any one of a high definition multimedia interface (HDMI), a mobile high-definition link (MHL), a universal serial bus (USB), a DisplayPort (DP), Thunderbolt, a video graphics array (VGA) port, a red-green-blue (RGB) port, a D-subminiature (D-SUB), or a digital visual interface (DVI). The input/output interface 196 may input/output at least one of the audio signal or a video signal. According to an implementation example, the input/output interface 196 may include a port for inputting and outputting only the audio signal and a port for inputting and outputting only the video signal as its separate ports, or may be implemented as a single port for inputting and outputting both the audio signal and the video signal. Meanwhile, the electronic apparatus 100′ may transmit at least one of the audio and video signals to the external device (e.g., the external display device or an external speaker) through the input/output interface 196. In detail, an output port included in the input/output interface 196 may be connected to the external device, and the electronic apparatus 100′ may transmit at least one of the audio signal or the video signal to the external device through the output port.

According to the above-described example, the electronic apparatus 100 may identify a subsequent predicted user behavior based on the user behavior or the context and proactively provide the content associated with the user behavior. Accordingly, a user convenience may be enhanced and a user satisfaction may be enhanced.

Meanwhile, according to an embodiment of the present disclosure, the various embodiments described above may be implemented in software including an instruction stored on a machine-readable storage medium (e.g., a computer-readable storage medium). A machine may be a device that invokes the stored instruction from a storage medium, may be operated based on the invoked instruction, and may include the display device (e.g., display device A) according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online through an application store (e.g., PlayStore™). In case of the online distribution, at least a part of the computer program product may be at least temporarily stored or temporarily provided on a storage medium such as the memory of a manufacturer server, an application store server, or a relay server.

In addition, each of the components (e.g., modules or programs) according to the various embodiments described above may include a single entity or a plurality of entities, and some of the corresponding sub-components described above may be omitted or other sub-components may be further included in the various embodiments. In some embodiments or additionally, some of the components (e.g., the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus, comprising:
at least one sensor;
an image projector;
at least one processor comprising processing circuitry; and
a memory storing instructions which, when individually or collectively executed by the at least one processor, cause the electronic apparatus to:
obtain, using an artificial intelligence model, behavior pattern information about at least one behavior pattern corresponding to a user based on at least one of context information corresponding to the user and tracking information about the user obtained using the at least one sensor,
move the electronic apparatus to a location corresponding to a predicted behavior based on the behavior pattern information, and
provide display information corresponding to the predicted behavior using the image projector.

2. The electronic apparatus as claimed in claim 1, wherein the tracking information comprises user location information and user behavior history information, and
wherein the instructions, when individually or collectively executed by the at least one processor, further cause the electronic apparatus to:
obtain a probability value for each behavior pattern from among the at least one behavior pattern using the artificial intelligence model based on the user location information and the user behavior history information.

3. The electronic apparatus as claimed in claim 1, wherein the artificial intelligence model is trained using at least one of a reinforcement learning algorithm or a collaborative filtering algorithm.

4. The electronic apparatus as claimed in claim 2, further comprising at least one light-emitting element, and
wherein the instructions, when individually or collectively executed by the at least one processor, further cause the electronic apparatus to:
emit light using the at least one light-emitting element based on a probability value associated with a behavior pattern from among the at least one behavior pattern being greater than or equal to a threshold value.

5. The electronic apparatus as claimed in claim 2, wherein the at least one sensor comprises a red-green-blue (RGB) camera sensor, and
wherein the tracking information comprises the user location information, and
wherein the instructions, when individually or collectively executed by the at least one processor, further cause the electronic apparatus to:
identify a region in which the user is located from among a plurality of regions based on sensor data obtained using the at least one sensor while performing a patrol operation, and
obtain the probability value using the artificial intelligence model based on object location information associated with at least one object included in the region in which the user is located.

6. The electronic apparatus as claimed in claim 1, wherein the instructions, when individually or collectively executed by the at least one processor, further cause the electronic apparatus to:
obtain the tracking information based on sensor data obtained using at least one external device.

7. The electronic apparatus as claimed in claim 1, wherein the instructions, when individually or collectively executed by the at least one processor, further cause the electronic apparatus to:
obtain device usage information from an external device,
determine an application associated with the at least one behavior pattern based on the device usage information, and
provide application information corresponding to the application using the image projector.

8. The electronic apparatus as claimed in claim 7, wherein the instructions, when individually or collectively executed by the at least one processor, further cause the electronic apparatus to:
based on determining that the external device is present in a predetermined region, provide the application information based on a connection history between the electronic apparatus and the external device.

9. The electronic apparatus as claimed in claim 1, further comprising a communication circuit, and
wherein the instructions, when individually or collectively executed by the at least one processor, further cause the electronic apparatus to:
transmit the display information to a first device that is closest to a location corresponding to the predicted behavior from among at least one external device using the communication circuit.

10. The electronic apparatus as claimed in claim 1, further comprising a microphone, and
wherein the instructions, when individually or collectively executed by the at least one processor, further cause the electronic apparatus to:
based on a user voice input being received through the microphone, update a probability value corresponding to each behavior pattern from among the at least one behavior pattern using the artificial intelligence model according to the user voice input.

11. A method for operating an electronic apparatus, the method comprising:
obtaining, using an artificial intelligence model, behavior pattern information about at least one behavior pattern corresponding to a user based on at least one of context information corresponding to the user or tracking information about the user obtained using at least one sensor;
moving the electronic apparatus to a location corresponding to a predicted behavior based on the behavior pattern information; and
providing display information corresponding to the predicted behavior using an image projector.

12. The method as claimed in claim 11, wherein the tracking information comprises user location information and user behavior history information, and
wherein the method further comprises obtaining a probability value for each behavior pattern from among the at least one behavior pattern using the artificial intelligence model based on the user location information and the user behavior history information.

13. The method as claimed in claim 11, wherein the artificial intelligence model is trained using at least one of a reinforcement learning algorithm or a collaborative filtering algorithm.

14. The method as claimed in claim 12, further comprising:
emitting light using at least one light-emitting element based on a probability value associated with a behavior pattern from among the at least one behavior pattern being greater than or equal to a threshold value.

15. A storage medium storing computer-readable instructions which, when executed by at least one processor of an electronic apparatus, cause the electronic apparatus to:
obtain, using an artificial intelligence model, behavior pattern information about at least one behavior pattern corresponding to a user based on at least one of context information corresponding to the user or tracking information about the user obtained using at least one sensor,
move the electronic apparatus to a location corresponding to a predicted behavior based on the behavior pattern information, and
provide display information corresponding to the predicted behavior using an image projector.

16. The storage medium as claimed in claim 15, wherein the tracking information comprises user location information and user behavior history information, and
wherein the instructions, when individually or collectively executed by the at least one processor, further cause the electronic apparatus to:
obtain a probability value for each behavior pattern from among the at least one behavior pattern using the artificial intelligence model based on the user location information and the user behavior history information.

17. The storage medium as claimed in claim 15, wherein the artificial intelligence model is trained using at least one of a reinforcement learning algorithm or a collaborative filtering algorithm.

18. The storage medium as claimed in claim 16, further comprising at least one light-emitting element, and
wherein the instructions, when individually or collectively executed by the at least one processor, further cause the electronic apparatus to:
emit light using the at least one light-emitting element based on a probability value associated with a behavior pattern from among the at least one behavior pattern being greater than or equal to a threshold value.

19. The storage medium as claimed in claim 16, wherein the at least one sensor comprises a red-green-blue (RGB) camera sensor, and
wherein the tracking information comprises the user location information, and
wherein the instructions, when individually or collectively executed by the at least one processor, further cause the electronic apparatus to:
identify a region in which the user is located from among a plurality of regions based on sensor data obtained using the at least one sensor while performing a patrol operation, and
obtain the probability value using the artificial intelligence model based on object location information associated with at least one object included in the region in which the user is located.

20. The storage medium as claimed in claim 15, wherein the instructions, when individually or collectively executed by the at least one processor, further cause the electronic apparatus to:
obtain the tracking information based on sensor data obtained using at least one external device.
